(19) United States
(12) Patent Application Publication
(10) Pub. No.: US 2007/0197273 A1
(43) Pub. Date: Aug. 23, 2007

(54) Board game system, game device, storage medium storing game program

(75) Inventors: Ryunosuke Suzuki, Kyoto-shi (JP); Yoshinori Tsuchiyama, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/606,208

(22) Filed: Nov. 30, 2006

(30) Foreign Application Priority Data
Feb. 22, 2006 (JP) 2006-045203

(51) Int. Cl. A63F 13/00; A63F 9/24

(52) U.S. Cl. 463/1; 463/43; 463/16; 463/10

(57) ABSTRACT

A board game system includes a board 1 of a board game played by moving a gamepiece along a track formed by a plurality of spaces drawn on the board, and a game device 10 for displaying a predetermined image on a screen. The board includes at least one event space 5, 6, 7 drawn thereon indicating that an event is to be executed by using the game device when a gamepiece lands on the space. The game device includes: input accepting means 15 for accepting an input from a player; and event process executing means 31 for executing an event process corresponding to the event space when there is a player input obtained by the input accepting means.

### CROSS REFERENCE TO RELATED APPLICATION

The disclosure of Japanese Patent Application No. 2006-045203, filed on Feb. 22, 2006, is incorporated herein by reference.

### BACKGROUND OF THE INVENTION

1. Field of the Invention

The present invention relates to a game system using a board, a game device and a storage medium storing a game program and, more particularly, to a board game system using a game device and a board, a game device and a storage medium storing a game program.

2. Description of the Background Art

In a conventional snakes and ladders-type game using a board made of paper, or the like, each player moves one's gamepiece through a number of fixed spaces drawn on the board according to the roll of dice, aiming at advancing the gamepiece from start to goal. Also suggested in the art is a snakes and ladders-type board game using a game device, instead of a paper board. In such a board game, there are provided a board, gamepieces and dice all in a virtual game space, wherein the players roll the dice via the controller of the game device and the gamepieces are advanced according to the roll of the dice. Also suggested in the art is a game device provided with a dedicated game board, wherein the board itself is connected to the game device (e.g., Japanese Laid-Open Patent Publication No. 64-8992). A board of this type includes many switches provided thereon, each switch representing a space to land on. As the switch is pressed by a gamepiece, the status of the game is inputted to the game device. Thus, the dedicated game board itself is connected to the game device as an input device.

However, conventional board games as described above have the following problems. First, a paper-based snakes and ladders-type game as described above is won or lost based heavily solely on luck on dice, and events printed on different spaces (e.g., “lose turn”) are fixed, whereby the gameplay is likely to be monotonous. In contrast, with a board game using a game device as described above, there may be a mini-game battle using the computer of the game device or a surprise event may be introduced in the game. Thus, there is an improvement made in an attempt not to make the gameplay monotonous. However, the spaces and the gamepieces will appear small and difficult to see if the entire board is displayed within the screen. Therefore, where there are four players, for example, a portion of the board around the gamepiece of the player who has the turn to roll the dice is displayed on an enlarged scale, and the entire board is not displayed. Therefore, it is difficult to grasp the status of the game across the board. It is also difficult for the other three players to grasp the status of the game near their own gamepieces or the overall status of the game. Therefore, a player will be bored while waiting for its turn to come. With the game device disclosed in Patent Document 1, the game board itself needs to be provided with switch mechanisms and means for transferring data to the game device. Therefore, the board will be expensive and complicated relative to an ordinary paper board.

### SUMMARY OF THE INVENTION

Therefore, an object of the present invention is to provide a novel board game system, a game device and a storage medium storing a game program, in which an analog gameplay of those board games using a board made of paper, or the like, is combined with a digital gameplay of those board games using a game device.

The present invention has the following features to attain the object mentioned above. Note that parenthetic expressions in the following section (reference numerals, supplementary explanations, etc.) are merely to indicate the correlation between what is described in the following section and what is described in the description of the preferred embodiments set out further below in the present specification, and are in no way intended to restrict the scope of the present invention.

A first aspect of the present invention is directed to a board game system, including a board (1) of a board game played by moving a gamepiece along a track formed by a plurality of spaces drawn on the board, and a game device (10) for displaying a predetermined image on a screen. The board includes at least one event space (5, 6, 7) drawn thereon indicating that an event is to be executed by using the game device when a gamepiece lands on the space. The game device includes: input accepting means (15) for accepting an input from a player; and event process executing means (31) for executing an event process corresponding to the event space when there is a player input obtained by the input accepting means (S10, S11).

In a second aspect based on the first aspect, the game device further includes event space image storage means (35) and event space display control means (S41). The event space image storage means is means for storing image data corresponding to the event space. The event space display control means is means for displaying the event space image by using the image data. The event process executing means executes the event process when the event space image displayed by the event space display control means is selected by the player via the input accepting means.

In a third aspect based on the second aspect, a plurality of types of event spaces are drawn on the board. The event space image storage means stores a plurality of image data corresponding to the plurality of types of event spaces. The event space display control means includes menu display means (S41) for listing the plurality of types of event space images by using the plurality of image data. The event process executing means executes the event process corresponding to the event space image selected by the player from among the listed event space images.

In a fourth aspect based on the first aspect, the game device further includes: history parameter storing means for storing a history parameter indicating an execution history of the event process; and history parameter updating means for updating the history parameter each time the event process is executed in response to a player input obtained by the input accepting means. The history parameter updating means updates the history parameter each time the event process is executed, for example. The history parameter may be updated only if a particular condition (e.g., the history parameter being less than or equal to, or greater than or equal to, a predetermined value) is satisfied when the event process is executed. The history parameter may be updated when the event process is executed and when another factor arises if the event process is not executed (for example, the history parameter may be updated a predetermined amount of time after the start of the game). The game device further executes a predetermined process at a predetermined point in time according to the history parameter.

In a fifth aspect based on the fourth aspect, the game device executes the predetermined process before or after executing the event process when the history parameter satisfies a predetermined condition.

In a sixth aspect based on the fourth aspect, the board game is played by advancing a gamepiece according to a value of a die. The game device further includes die control means for repeating a process of determining a value of the die according to a player input (S7) and displaying the value on a screen. The game device executes the predetermined process before or after the process executed by the die control means when the history parameter satisfies a predetermined condition.

In a seventh aspect based on the first aspect, the game device further includes: history parameter storing means for storing a history parameter indicating an execution history of the event process; and history parameter updating means for updating the history parameter each time the event process is executed in response to a player input obtained by the input accepting means. The event process executing means executes the event process in a special mode or executes a special process instead of executing the event process when the history parameter satisfies a predetermined condition.

In an eighth aspect based on the first aspect, the board game is played by advancing a gamepiece according to a value of a die. The game device further includes: history parameter storing means for storing a history parameter indicating an execution history of the event process; history parameter updating means for updating the history parameter each time the event process is executed in response to a player input obtained by the input accepting means; and die control means for determining a value of the die according to a player input and displaying the value on a screen. The die control means uses rules for determining the value that are varied between when the history parameter does not satisfy a predetermined condition and when the history parameter satisfies a predetermined condition.

In a ninth aspect based on the first aspect, the history parameter storing means stores an execution count parameter indicating the number of times the event process has been executed. The history parameter updating means updates the execution count parameter each time the event process is executed in response to a player input obtained by the input accepting means. A predetermined process is executed at a predetermined point in time when the execution count parameter becomes equal to a predetermined count.

In a tenth aspect based on the first aspect, the game device is a portable-type game device. A game device area is drawn on the board for placing the portable game device therein. The event process includes a moving instruction process for displaying an instruction to move a position of the portable game device placed in the game device area.

In an eleventh aspect based on the tenth aspect, the moving instruction process selects one of a plurality of directions on a screen of the portable game device based on a random value and displaying the selected direction on the screen.

In a twelfth aspect based on the eleventh aspect, the board includes a plurality of types of boards. The game device further includes board selection means for selecting a board to be used from among the plurality of boards based on a player input. The moving instruction process determines the plurality of directions and selects one of the plurality of directions according to the board selected by the board selection means.

In a thirteenth aspect based on the eleventh aspect, the moving instruction process continuously displays the direction in which the portable game device is to be moved until the player makes a predetermined input.

In a fourteenth aspect based on the first aspect, the board includes a plurality of types of boards. The game device further includes board selection means for selecting a board to be used from among the plurality of boards based on a player input. The event process includes a board-specific event process specific to each board. The event process executing means executes the board-specific event process specific to the board selected by the board selection means.

In a fifteenth aspect based on the fourteenth aspect, a board-specific event space specific to each board is drawn on the board. The event process includes a board-specific event process for each board-specific event space. The game device further includes: event space image storage means for storing image data corresponding to the board-specific event space; and event space display control means for displaying, by using the image data, one of the board-specific event space images corresponding to the board selected by the board selection means. The event process executing means executes the board-specific event process corresponding to the board-specific event space when the board-specific event space image displayed by the event space display control means is selected by the player via the input accepting means.

In a sixteenth aspect based on the fourteenth aspect, a board-specific event space specific to each board and a common event space common to a plurality of boards are drawn on the board. The event process includes a board-specific event process corresponding to the board-specific event space and a common event process corresponding to the common event space. The game device further includes: event space image storage means for storing image data corresponding to the board-specific event space and image data corresponding to the common event space; and event space display control means for listing, by using the image data, the common event space image and one of the board-specific event space images corresponding to the board selected by the board selection means. The event process executing means executes the board-specific event process corresponding to the board-specific event space image when the board-specific event space image displayed by the event space display control means is selected by the player via the input accepting means, and executes the common event process when the common event space image displayed by the event space display control means is selected by player via the input accepting means.

In a seventeenth aspect based on the first aspect, the board game is played by advancing a gamepiece according to a value of a die. The game device further includes die control means for displaying a prompt on the screen to make an input for determining a value of a die to accept a player input, and for determining the value of the die in response to the input to display the value on the screen. When a first input (S20) is made by the player after the value is displayed, the die control means executes again a process by the die control means, whereas when a second input (S10) is made by the player after the value is displayed, the die control means executes the event process and executes again a process by the die control means after the event process is executed.

In an eighteenth aspect based on the seventeenth aspect, the game device further includes: character image storage means for storing a plurality of character images; and display order determining means for determining a cyclic order in which the character images are displayed. The die control means displays a character image according to the determined display order together with, or prior to, the prompt, and displays the value, after which when the first input is made, the die control means displays the next character image according to the determined display order together with, or prior to, the prompt.

In a nineteenth aspect based on the eighteenth aspect, if a third input (S7) is made by the player after the die control means displays the prompt, the game device determines the value of the die based on the input, whereas if a fourth input (S13) is made by the player after the die control means displays the prompt, the game device displays the next character image according to the determined display order together with, or prior to, the prompt.

In a twentieth aspect based on the first aspect, the board game is played by advancing a gamepiece according to a value of a die. The game device further includes character image storage means, display order determining means and die control means. The character image storage means is means for storing a plurality of character images. The display order determining means is means for determining a cyclic order in which the character images are displayed. The die control means is means for displaying a prompt on the screen to make an input for determining a value of a die to accept a player input, and for determining the value of the die in response to the input to display the value on the screen. The die control means displays a character image according to the determined display order together with, or prior to, the prompt. The event process is a mini-game process in which a character is controlled according to a player input using the character image.

In a twenty-first aspect based on the twentieth aspect, the game device further includes post-mini-game die control means for selecting one character image based on the mini-game process, displaying a prompt to make an input for determining a value of the die along with a display of the character image or after a display of the character image to accept a player input, and for determining the value of the die in response to the input to display the value on the screen.

A twenty-second aspect of the present invention is directed to a board game system, including a board of a board game played by moving a gamepiece along a track formed by a plurality of spaces drawn on the board, and a portable game device for displaying a predetermined image on a screen. The spaces, a game device area in which the portable game device is placed, and a connection between a space and the game device area are drawn on the board. The game device further includes display control means for displaying a predetermined game image on a screen of the portable game device and for changing how the game image is displayed according to an input from a player.

In a twenty-third aspect based on the twenty-second aspect, the display control means displays an indication on a screen of the portable game device indicating that a gamepiece cannot pass through a position of the portable game device, performs a predetermined process according to an input from the player, and displays an indication indicating that a gamepiece is now allowed to pass through the position of the portable game device if a result of the process satisfies a predetermined condition.

In a twenty-fourth aspect based on the twenty-second aspect, the board includes a plurality of game device areas drawn thereon. The display control means displays an indication on a screen of the portable game device indicating that a gamepiece cannot pass through a position of the portable game device, performs a predetermined process according to an input from the player, and displays an indication instructing the player to move the position of the game device placed in the game device area if a result of the process satisfies a predetermined condition.

In a twenty-fifth aspect based on the twenty-second aspect, the board game is played by advancing a gamepiece according to a value of a die. The portable game device further includes die control means for displaying a prompt on the screen to make an input for determining a value of a die to accept a player input, and for determining the value of the die in response to the input to display the value on the screen. The portable game device displays the prompt or the value together with the predetermined game image at the same time on the screen.

A twenty-sixth aspect of the present invention is directed to a board game system, including a board of a board game played by moving a gamepiece along a track formed by a plurality of spaces drawn on the board, and a game device for displaying a predetermined image on a screen. The board game is played by advancing a gamepiece according to a value of a die. The game device includes character image storage means, display order determining means and die control means. The character image storage means is means for storing a plurality of character images. The display order determining means is means for determining a cyclic order in which the character images are displayed. The die control means is means for displaying a prompt on the screen to make an input for determining a value of a die to accept a player input, and for determining the value of the die in response to the input to display the value on the screen. The die control means displays a character image according to the determined display order together with, or prior to, the prompt, and displays the value, after which when the first input is made, the die control means displays the next character image according to the determined display order together with, or prior to, the prompt.

In a twenty-seventh aspect based on the twenty-sixth aspect, if a third input is made by the player after the die control means displays the prompt, the game device determines the value of the die based on the input, whereas if a fourth input is made by the player after the die control means displays the prompt, the game device displays the next character image according to the determined display order together with, or prior to, the prompt.

In a twenty-eighth aspect based on the twenty-sixth aspect, the game device further includes: history parameter storing means for storing a history parameter indicating an input history of the player; and history parameter updating means for updating the history parameter each time a predetermined process is executed according to a player input obtained by the input accepting means. The die control means uses rules for determining the value that are varied according to the history parameter.

A twenty-ninth aspect of the present invention is directed to a board game system, including a board of a board game played by moving a gamepiece along a track formed by a plurality of spaces drawn on the board, and a game device for displaying a predetermined image on a screen, wherein: the game device includes input accepting means (15), progress-related process means (31), history parameter storing means (35) and history parameter updating means (31). The input accepting means is means for accepting an input from a player. The progress-related process means is means for executing a process relating to a progress of the board game when there is a player input obtained by the input accepting means. The history parameter storing means is means for storing a history parameter indicating an execution history of the progress-related process by the progress-related process means. The history parameter updating means is means for updating the history parameter in response to execution of the progress-related process by the progress-related process means. The game device executes a special process relating to the progress of the board game according to the history parameter. The special process is a process executed at a predetermined point in time before or after the progress-related process, or a process executed instead of the progress-related process. Moreover, the special process includes executing the progress-related process in a special mode.

A thirtieth aspect of the present invention is directed to a game device for displaying a predetermined image on a screen, the game device being used together with a board of a board game played by moving a gamepiece along a track formed by a plurality of spaces drawn on the board, wherein the board includes at least one event space drawn thereon indicating that an event is to be executed by using the game device when a gamepiece lands on the space. The game device includes an input accepting section (15) and an event process executing section (31). The input accepting section is a section for accepting an input from a player. The event process executing section is a section for executing an event process corresponding to the event space when there is a player input obtained by the input accepting means.

A thirty-first aspect of the present invention is directed to a game device for displaying a predetermined image on a screen, the game device being used together with a board of a board game played by moving a gamepiece along a track formed by a plurality of spaces drawn on the board. The game device includes an input accepting section (15), a progress-related process section (31), a history parameter storing section (35) and a history parameter updating section (31). The input accepting section is a section for accepting an input from a player. The progress-related process section is a section for executing a process relating to a progress of the board game when there is a player input obtained by the input accepting means. The history parameter storing section is a section for storing a history parameter indicating an execution history of the progress-related process by the progress-related process means. The history parameter updating section is a section for updating the history parameter in response to the execution of the progress-related process by the progress-related process means. The game device executes a special process relating to the progress of the board game according to the history parameter.

A thirty-second aspect of the present invention is directed to a storage medium storing a game program to be executed by a computer of a game device for displaying a predetermined image on a screen, the game device being used together with a board of a board game played by moving a gamepiece along a track formed by a plurality of spaces drawn on the board, wherein the board includes at least one event space drawn thereon indicating that an event is to be executed by using the game device when a gamepiece lands on the space. The game program instructs the computer to perform an input accepting step (S6) and an event process executing step (S12). The input accepting step is a step of detecting an input from a player. The event process executing step is a step of executing an event process corresponding to the event space when a player input is detected in the input accepting step.

A thirty-third aspect of the present invention is directed to a storage medium storing a game program to be executed by a computer of a game device for displaying a predetermined image on a screen, the game device being used together with a board of a board game played by moving a gamepiece along a track formed by a plurality of spaces drawn on the board. The game program instructs the computer to perform an input accepting step (S58), a progress-related process step (S56-S73), a history parameter storing step (S74), a history parameter updating step (S74) and a special process step (S99). The input accepting step is a step of detecting an input from a player. The progress-related process step is a step of executing a process relating to the progress of the board game when a player input is detected in the input accepting step. The history parameter storing step is a step of storing a history parameter indicating an execution history of the progress-related process in the progress-related process step. The history parameter updating step is a step of updating the history parameter in response to the execution of the progress-related process in the progress-related process step. The special process step is a step of executing a special process relating to a progress of the board game according to the history parameter.

According to the first aspect, with the information processing function of the game device, it is possible to vary the progress of the board game, and the player can see the entire board all the time. Thus, it is possible to provide a game that can be played without a stress, where a player can easily grasp the status of the game even while the player is waiting for the turn, and where a player can easily devise strategies while enjoying various event processes using a game device. Since it is not necessary to provide the board with special mechanisms, the cost for producing the board can be reduced.

According to the second to third aspects, images corresponding to event spaces drawn on the board can be displayed on the game device, whereby it is possible to present events in such a manner that it is easy for the player to recognize the presence of the events.

According to the fourth to ninth aspects, the progress of the game is estimated based on history data for the player's operation to start an event process and progress-related history data, e.g., the number of times the event process has been executed during the game, and a predetermined process, or the like, is executed according to the estimated progress of the game. Thus, it is possible to estimate the progress of the game, without requiring the player to perform an extra step, so as to introduce more unpredictability to the gameplay, thus providing a game that players do not get bored with. Moreover, some adjustment can be made so that one player will not be too far ahead of, or behind, the others, thus keeping the game exciting.

According to the tenth to twelfth aspects, the game device itself can be used as an object on the board that has an influence on the progress of the board game. This makes it possible to indicate to the player that a gamepiece cannot pass through a certain position, etc. Moreover, the game device can be moved across the board in such a manner that the gamepieces may accidentally be moved around, thus providing a game with more unpredictability. According to the fourteenth aspect, how the game device itself is used in the game can be varied for each type of a board. Thus, it is possible to make each board unique.

According to the thirteenth to sixteenth aspects, there can be provided events specific to each of a plurality of boards, thus providing a varied gameplay with one game device and the plurality of boards. According to the eighteenth aspect, there can be provided some events common to different boards, thus reducing the size of the game program.

According to the seventeenth aspect, the game device can be used as a die. Moreover, it is possible to provide a user interface that assists in a smooth gameplay of the board game while mixing die roll processes and event processes with each other.

According to the eighteenth to nineteenth aspects, the display order is determined, and character images are displayed based on the order, whereby each player can readily perceive that the player's turn has come. According to the twenty-second aspect, it is possible to provide a user interface with which the game can be played smoothly.

According to the twentieth aspect, it is possible to provide mini-games played by a player controlling a character, whereby the player's skills can be reflected in the development of the game. Thus, even if a player is losing, the player may be given a chance to come back, thus keeping the game exciting.

According to the twenty-first aspect, a player may be awarded an extra roll of a die depending on the results of a mini-game. Thus, it is possible to realize a varied gameplay of a board game, and to provide a user interface where it is easy to see who has earned the right to roll a die depending on the results of a mini-game.

According to the twenty-second to twenty-fifth aspects, the game device itself can be used as an object that has an influence on the progress of the board game. Moreover, a gamepiece may be allowed to pass through the position of the game device, and the game device may be moved from one place to another, when a certain condition is satisfied. Thus, it is possible to provide a varied gameplay.

According to the twenty-sixth to twenty-seventh aspects, a character is displayed on the game device to indicate to the players who's turn it is. Thus, each player can easily see if it is the player's turn. According to the thirtieth aspect, it is possible to provide a user interface with which the game can be played smoothly.

According to the twenty-eighth aspect, it is possible to estimate the progress of the game by using die inputs without requiring separate inputs, and to adjust the value of the die depending on the estimated progress of the game. Thus, some adjustment can be made so that one player will not be too far ahead of, or behind, the others, thus keeping the game exciting.

According to the twenty-ninth aspect, it is possible to estimate the progress of the game based on history data regarding the progress of the game, and it is possible to execute processes relating to the progress of the game according to the estimated progress of the game. Thus, it is possible to prevent the gameplay from becoming monotonous, and some adjustment can be made so that one player will not be too far ahead of, or behind, the others, thus keeping the game exciting.

According to the thirtieth aspect, it is possible to realize effects similar to those of the first aspect.

According to the thirty-first aspect, it is possible to realize effects similar to those of the twenty-ninth aspect.

According to the thirty-second aspect, it is possible to realize effects similar to those of the first aspect.

According to the thirty-third aspect, it is possible to realize effects similar to those of the twenty-ninth aspect.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of a board according to an embodiment of the present invention;

FIG. 2 is an external view of a game device 10;

FIG. 3 shows an internal configuration of the game device;

FIG. 4 shows an exemplary image of an iron ball rolling down;

FIG. 5 shows the game device 10 being moved away from a game device area 8;

FIG. 6 shows a memory map of a WRAM 35 shown in FIG. 2;

FIG. 7 is a flow chart showing an entire game process executed by the game device 10;

FIG. 8 is a flow chart showing an entire game process executed by the game device 10;

FIG. 9 shows an example of a character selection screen;

FIG. 10 shows an example of a message indicating the turn of a player;

FIG. 11 shows an example of a die roll screen;

FIG. 12 is a flow chart showing the details of a die roll process shown in step S8 of FIG. 7;

FIG. 13 is an exemplary screen showing the value of a die;

FIG. 14 shows an example of a space event menu;

FIG. 15 is a flow chart showing the details of a space event process shown in step S12 of FIG. 7;

FIG. 16 shows an example of a mini-game roulette screen;

FIG. 17 shows an example of a board where the game device 10 is used as an obstacle;

FIG. 18 shows another example of a board where the game device 10 is used as an obstacle;

FIG. 19 shows an example of a board where the game device 10 is moved from game device areas;

FIG. 20 shows a memory map according to a second embodiment of the present invention;

FIG. 21 is a flow chart showing a game process according to the second embodiment of the present invention;

FIG. 22 is a flow chart showing a game process according to the second embodiment of the present invention;

FIG. 23 is a flow chart showing the details of a die roll process shown in step S59 of FIG. 21;

FIG. 24 is a flow chart showing the details of a space event process shown in step S63 of FIG. 21.

### DESCRIPTION OF THE PREFERRED EMBODIMENTS

Embodiments of the present invention will now be described with reference to the drawings. The present invention is not limited to these embodiments.

### First Embodiment

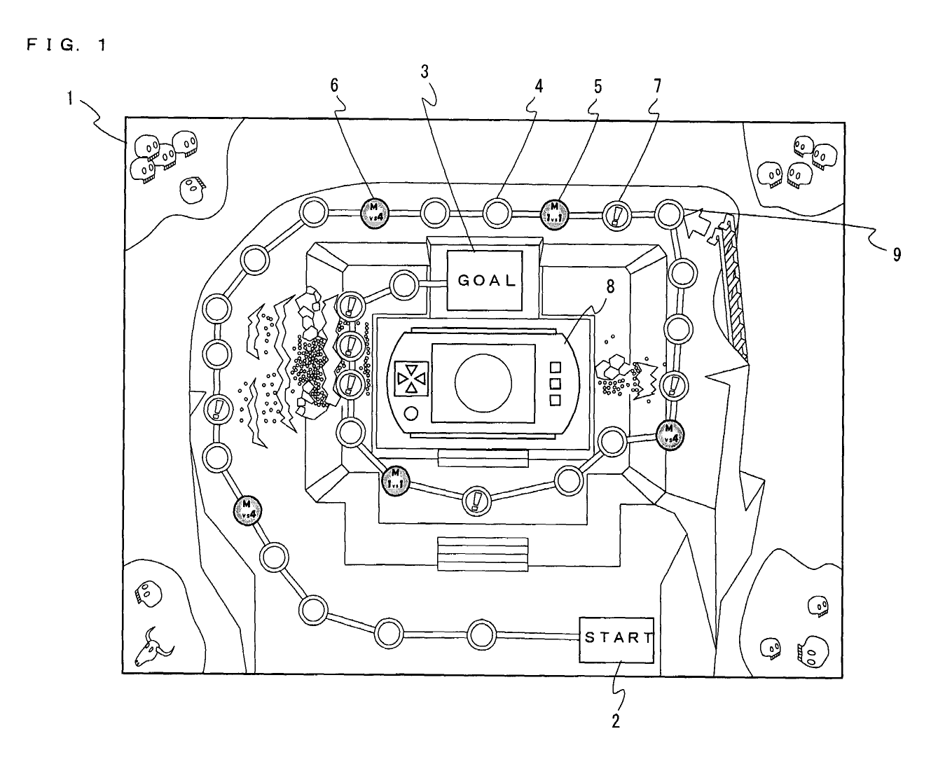

FIG. 1 is an external view of a board 1 according to a first embodiment of the present invention. The board 1 is not existing in a virtual space, but is a snakes and ladders-type game board with drawings printed on a real medium such as paper or plastic. Drawn on the board 1 are a start position 2, a goal position 3 and a plurality of spaces. Also drawn on the board 1 is a track connecting the plurality of spaces together leading from the start position 2 to the goal position 3. The spaces include normal spaces 4, and three types of event spaces, i.e., two-player battle spaces 5, four-player battle spaces 6 and board event spaces 7. Drawn in the center of the board 1 is an area (hereinafter referred to as the “game device area”) 8 for placing a game device 10 to be described later. While the present embodiment will be described with reference to the particular board 1 shown in FIG. 1, there are other boards different from one another in terms of the design of event spaces, etc.

A game device according to an embodiment of the present invention will now be described.

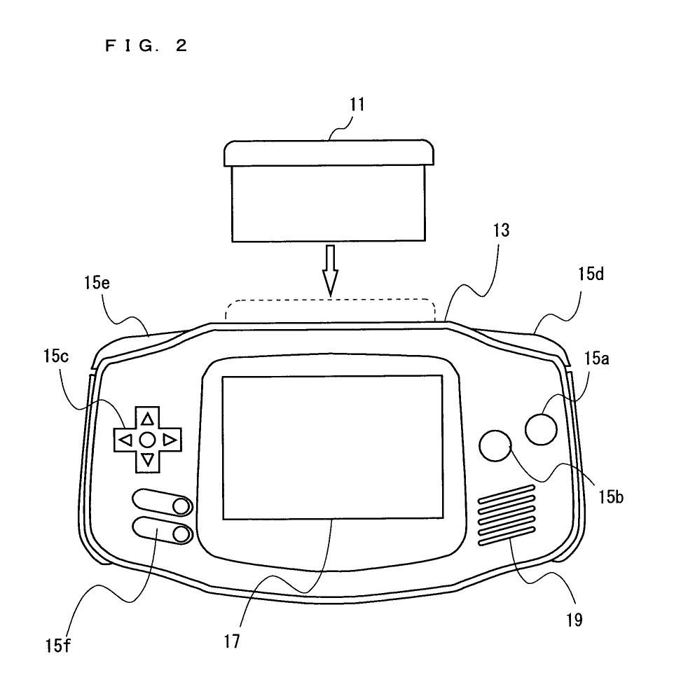

FIG. 2 shows the portable game device 10 (hereinafter referred to simply as the “game device”). The game device 10 includes a game device unit 13 and a cartridge 11. The game device unit 13 includes an LCD 17, a speaker 19, and a plurality of control keys (an A button 15a, a B button 15b, a cross-shaped key 15c, an R button 15d, an L button 15e, a start button 15f).

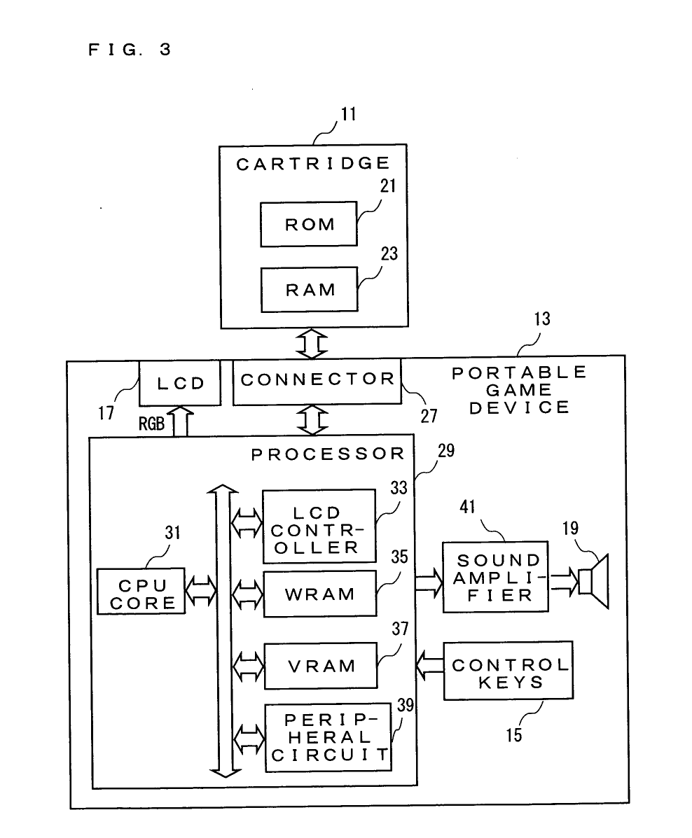

An internal configuration of the game device 10 will now be described with reference to FIG. 3. The cartridge 11 includes a ROM 21 storing a game program, and a RAM 23 for storing, as necessary, game data produced during the game process.

The game device unit 13 includes the LCD 17 for displaying a game image, a connector 27 for receiving the cartridge 11, a processor 29 for executing a game process based on the game program supplied from the cartridge 11, the speaker 19, a sound amplifier 41, and the control keys 15. The processor 29 includes a CPU core 31 for executing various processes based on the game program, an LCD controller 33 for driving the LCD 17, a WRAM 35 as a work memory of the CPU core 31, a VRAM 37 used for image processing, and a peripheral circuit 39 such as a sound circuit and a DMA circuit.

While the game program is supplied to the processor 29 of the game device unit 13 via the cartridge 11 in the present embodiment, the present invention is not limited thereto, but the game program may be supplied via a computer-readable storage medium such as a CD-ROM or a DVD. Alternatively, the game program may be supplied through a wired or wireless communications line. Alternatively, the game program may be pre-stored in a storage device provided in the game device unit 13. The present invention is applicable not only to a portable game device, but also to any other suitable type of a game device such as a home-console type game device.

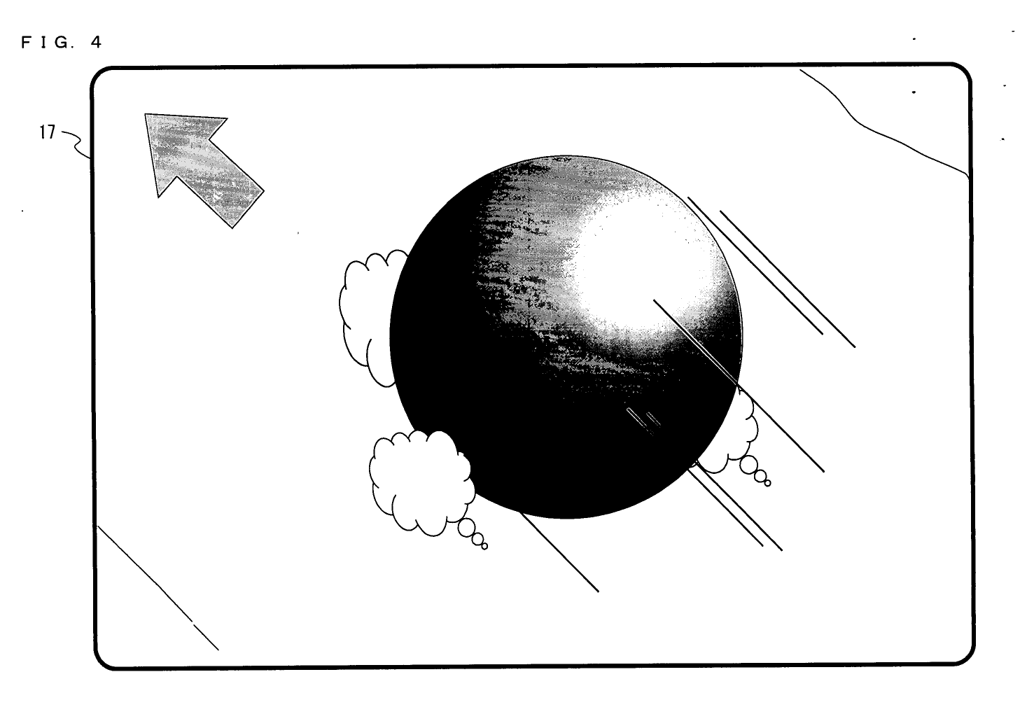

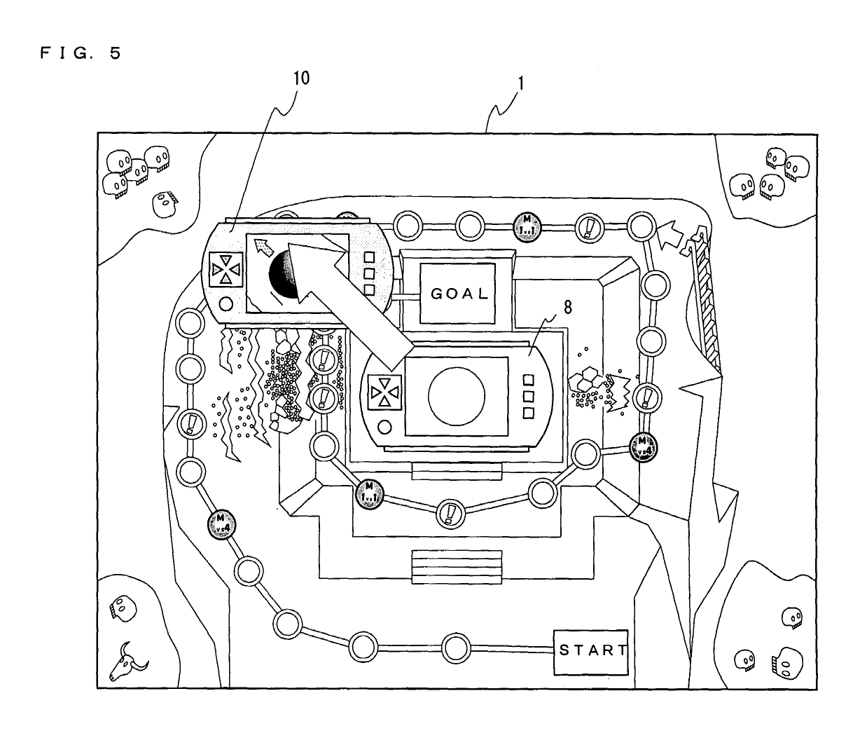

The game contemplated in the present embodiment will be outlined below with reference to FIGS. 1, 4 and 5. The game is a snakes and ladders-type game. First, a player selects a board to be used from among a plurality of paper boards, and inputs to the game device 10 which board has been selected to be played (the board 1 shown in FIG. 1 is used in the present embodiment). Also determined at this point are the order of play, and the character to be used by each player (the character to be displayed on the game device). Then, the game device 10 is placed in a game device area 8 of the board 1. The screen of the game device 10 displays which player's turn is next, and then displays the image of the character of the player and the image of a die. When the player who has the turn presses the A button 15a, the die is shown to roll and then the value of the die is determined and displayed. The player advances its gamepiece across the board 1 according to the displayed value. If the gamepiece lands on any event space, the player presses the L button 15e or the R button 15d of the game device 10. Then, the images of the battle spaces 5 and 6 and the board event space 7 are displayed on the game device 10. The player selects the type of space image corresponding to the space that the player has landed on. If the player has landed on the two-player battle space 5 or the four-player battle space 6, the player selects an image according to the battle space that the player has landed on. Then, a battle mini-game starts, in which the player battles with another player. Depending on the result of the mini-game, the player is allowed to take a favorable course of action, e.g., switch position with the defeated opponent player, move the gamepiece to any space, or roll a die again. When the player selects the image corresponding to the board event space 7, the game device 10 displays an image of an iron ball rolling down and an arrow indicating the direction in which the iron ball is rolling (see FIG. 4). The player moves the game device 10 off the game device area 8 in a direction as indicated by the arrow (see FIG. 5). In other words, the game device 10 is moved across the board as if it were the iron ball. Any gamepiece hit by the game device 10 being moved across the board is returned to start or moved to a normal space 9 near the upper end of a ladder drawn on the board 1. Then, the game device 10 is put back in the game device area 8. After a battle mini-game or after an event process, the next player takes the turn by rolling the die and advancing the gamepiece, as described above. By repeating the process as described above, each player attempts to reach the goal position 3.

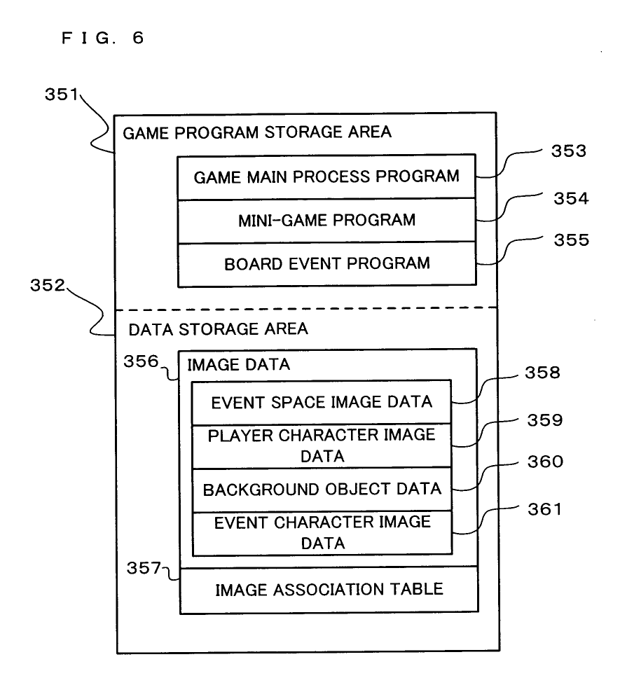

Various data used in the present embodiment will now be described. FIG. 6 shows a memory map of the WRAM 35 shown in FIG. 2. Referring to FIG. 6, the WRAM 35 includes a game program storage area 351 and a data storage area 352. The game program storage area 351 stores a game program to be executed by the CPU core 31, and the game program includes a game main process program 353, a mini-game program 354, a board event program 355, etc. These programs and data are read out from the ROM 21 and stored in the WRAM 35.

The game main process program 353 is a program for performing a game main routine as described above. The mini-game program 354 is a program for executing a mini-game by using image data 251 to be described later. Since there are more than one mini-games, a program for listing the mini-games in a menu form and a program for randomly selecting a mini-game to be executed are also included. The mini-game programs are stored in such a manner that two-player mini-game programs and four-player mini-game programs can be distinguished from each other. The board event program 355 is a program for executing an event process associated with the board event space 7 on the board 1. For example, with the board 1 shown in FIG. 1, a program for determining the direction in which an iron ball rolls down and for displaying the image of the iron ball rolling down (see FIG. 4) is included. A board event program is stored for each type of a board. In a case where a player is instructed in the event process to move the game device, a display process for instructing the movement is provided for each of a plurality of directions, and one of the display processes is selected by the event process. The movement instruction display process executed in the event process is different for each type of a board, and each type of a board has a different set of movement directions.

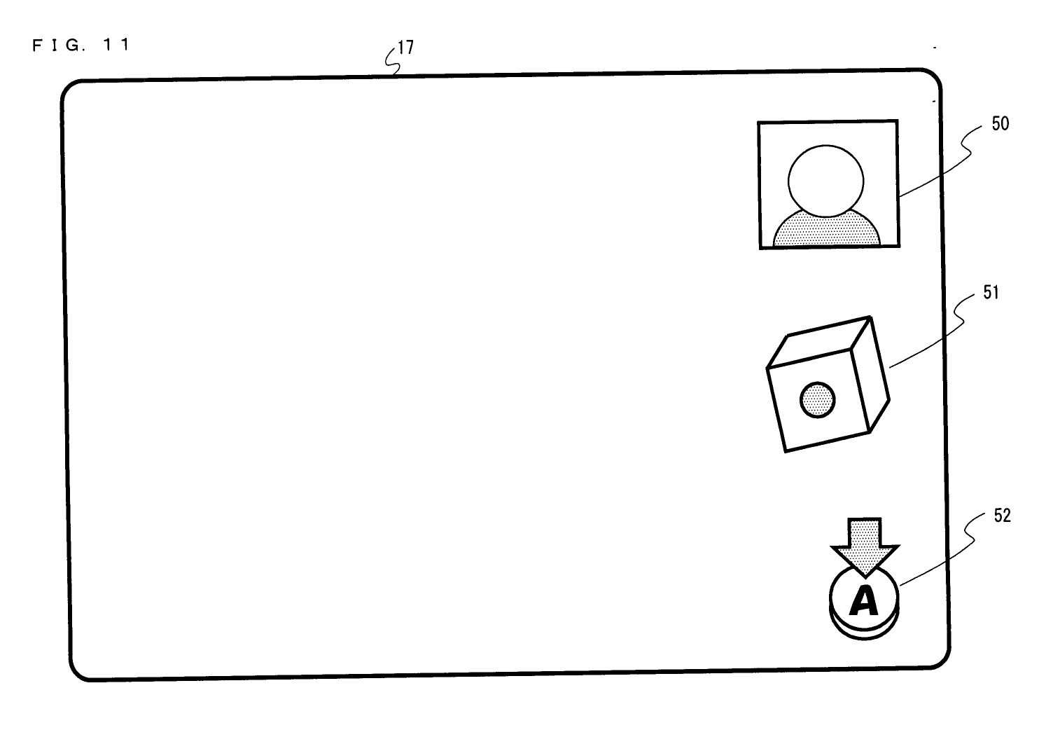

The data storage area 352 stores data such as image data 356 and an image association table 357, and also stores various flags. The image data 356, being data for producing a game image, includes event space image data 358, player character image data 359, background object data 360, and predetermined event character image data 361. In the player character image data, image data used for indicating the turn (see 50 in FIG. 11, referred to as “turn indication image data”) may be associated with the corresponding image data used in mini-games (“mini-game image data”).

The image association table 357 is a table showing the association between different types of boards and the event space image data 358 to be used with the corresponding boards. Thus, different boards have different event spaces. The image data 356 includes space image data for all event spaces. Therefore, the image association table 357 is provided for identifying which event space image to be used for each board.

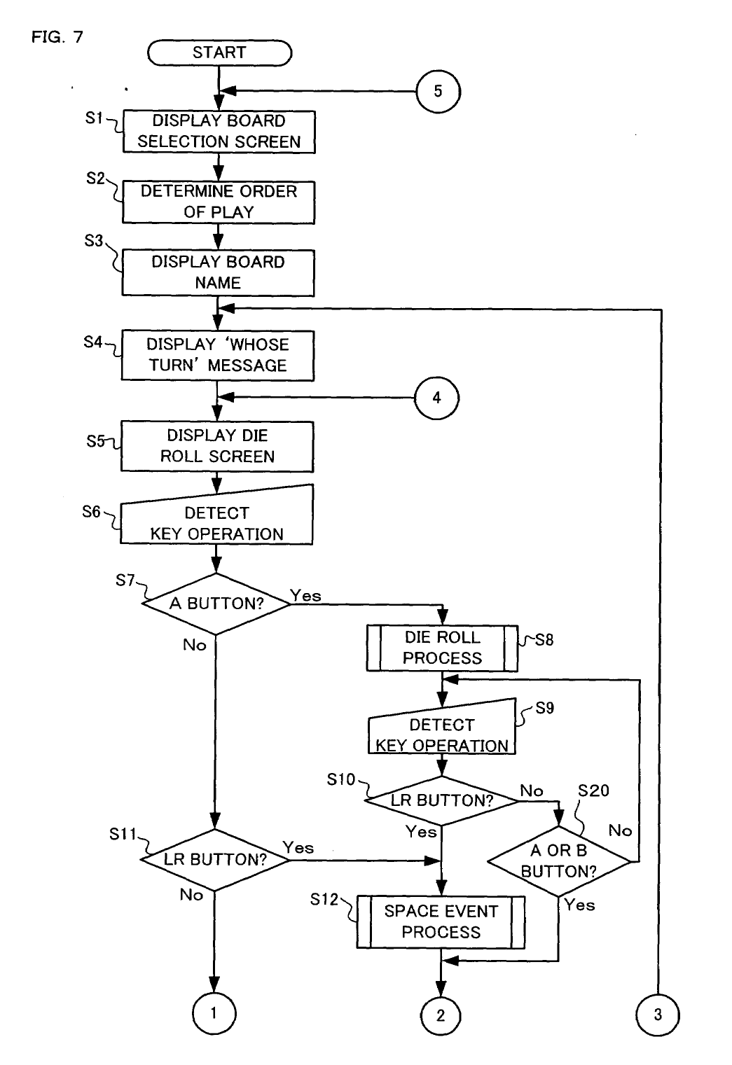

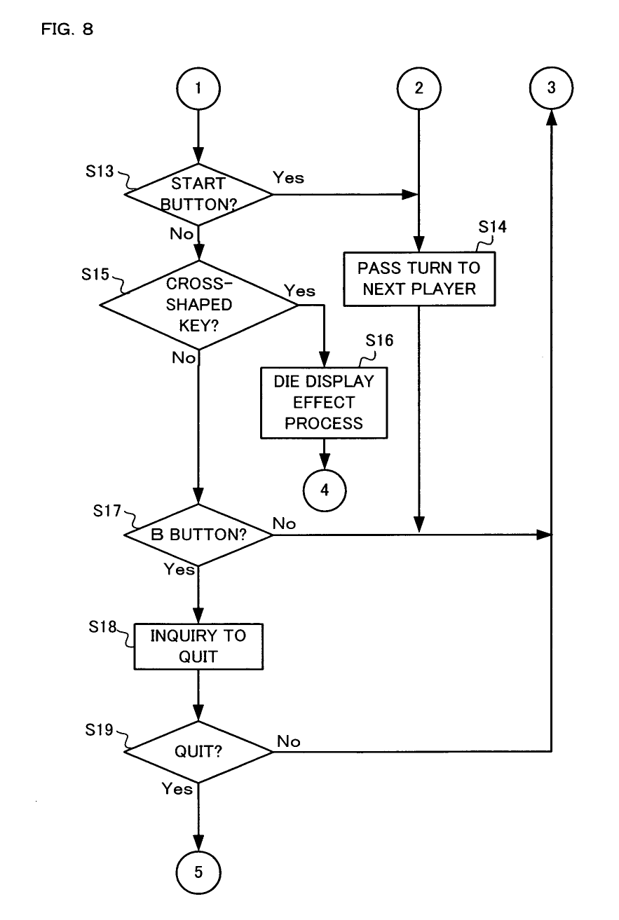

Referring now to FIGS. 7 to 16, the game process executed by the game device 10 will be described. FIGS. 7 and 8 are flow charts showing the entire game process executed by the game device 10.

Referring to FIG. 7, after the power of the game device 10 is turned ON to start the game process, the board selection screen is first displayed (step S1). On this screen, the player selects a board to be used. Herein, the board 1 shown in FIG. 1 is selected. The CPU core 31 refers to the image association table 357 to read out the space image data 358 for event spaces used in the selected board.

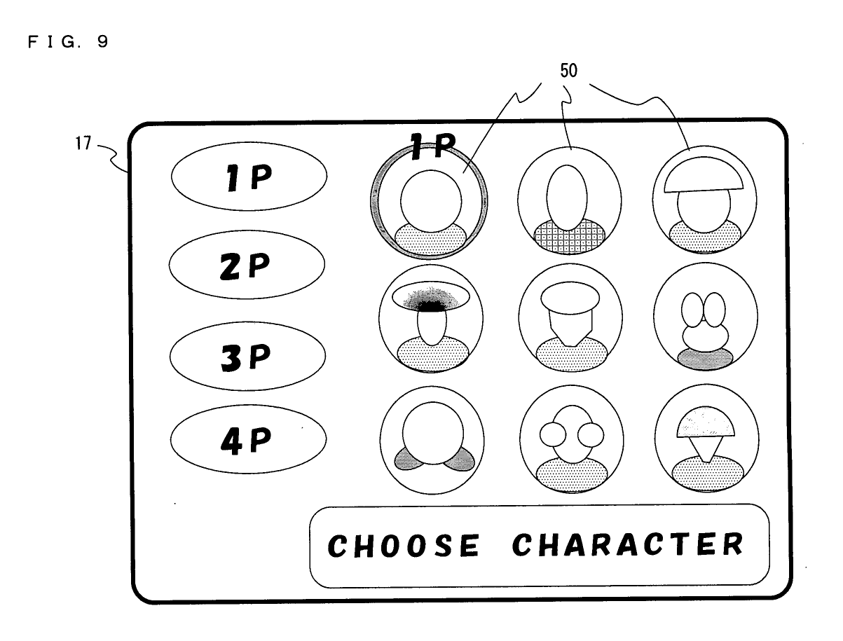

Then, the order of play and the character to be used by each player are determined (step S2). In step S2, a character selection screen as shown in FIG. 9 is displayed. Each player (1P-4P) selects a character 50 to be used. At this point, the order of play is determined by using random numbers, for example. It is assumed herein that the game is played in the order of 1P, 2P, 3P and 4P. Although not shown in FIG. 6, the character selection information and the order of play information are stored in the WRAM 35.

After determining the order of play, etc., the name of the board is then displayed (step S3). With the board 1 of FIG. 1, the name “Treasure Hunt” is displayed over a predetermined amount of time. The game device 10 also displays a message instructing a player to place the game device 10 on the board 1. In response to the message, the player places the game device 10 in the game device area 8 of the board 1. Note that steps S1 to S3 are a preparatory process executed before the board game starts, and step S4 and subsequent steps are a process relevant to the progress of the board game to be executed while the board game is being played (hereinafter referred to as the “progress-related process”).

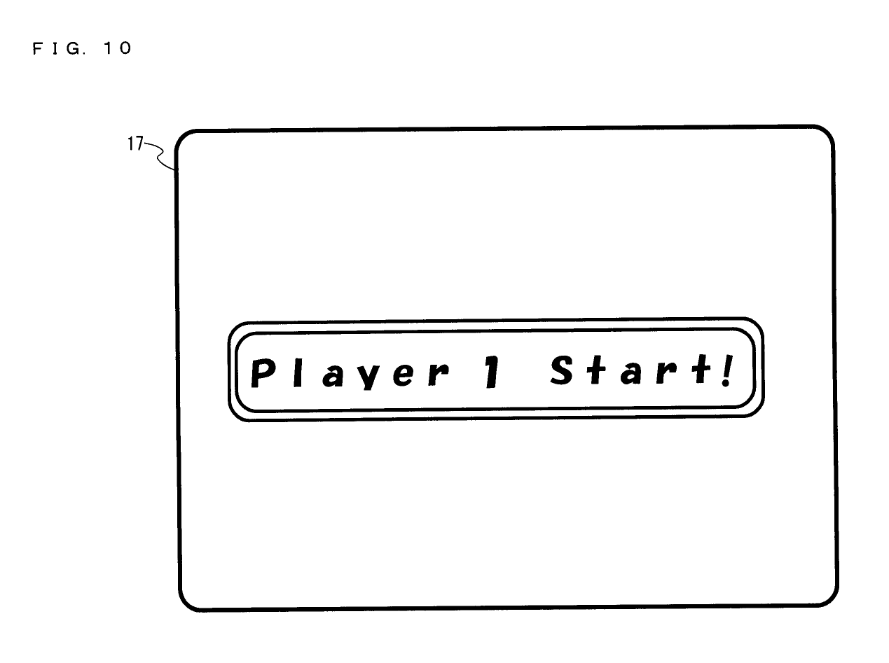

Then, the game device 10 displays a message indicating the turn of a player as shown in FIG. 10 (step S4). Then, the game device 10 displays a die roll screen as shown in FIG. 11 (step S5). Referring to FIG. 11, using the character selection information and the order of play information, the game device 10 displays on the die roll screen the character image 50 whose turn has come, a die image 51, and an operation guide 52, being a prompt to roll the die (it is indicated in the example of FIG. 11 that the die is rolled by pressing the A button). The outline of the input operation on the die roll screen will be described. The die is rolled by pressing the A button 15a on the die roll screen. If the L or R button 15d or 15e is pressed, a space event menu is displayed. If the start button 15f is pressed, the player loses the turn and it will be the next player's turn (this can be used, for example, after landing on a “lose turn” space). If the B button 15b is pressed, the die roll screen is canceled, and the process returns to the board selection screen of step S1. If the cross-shaped key 15c is pressed, the die can be spun in place, instead of being rolled, according to the input direction of the cross-shaped key 15c.

When the die roll screen is displayed, the player who has the turn performs an operation that the player wishes to. In response, the CPU core 31 detects the key operation (step S6). If the A button is pressed (YES in step S7), a die control process (hereinafter referred to as the “die roll process”) for rolling the die and determining the value of the die roll is performed (step S8).

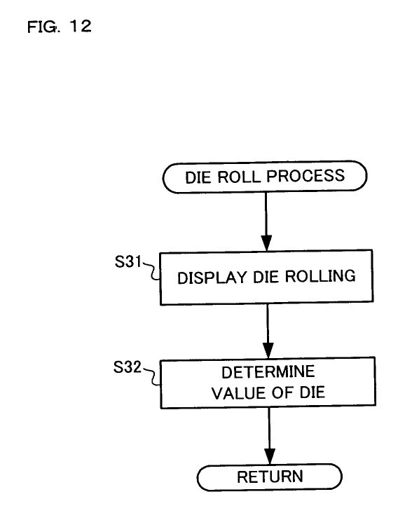

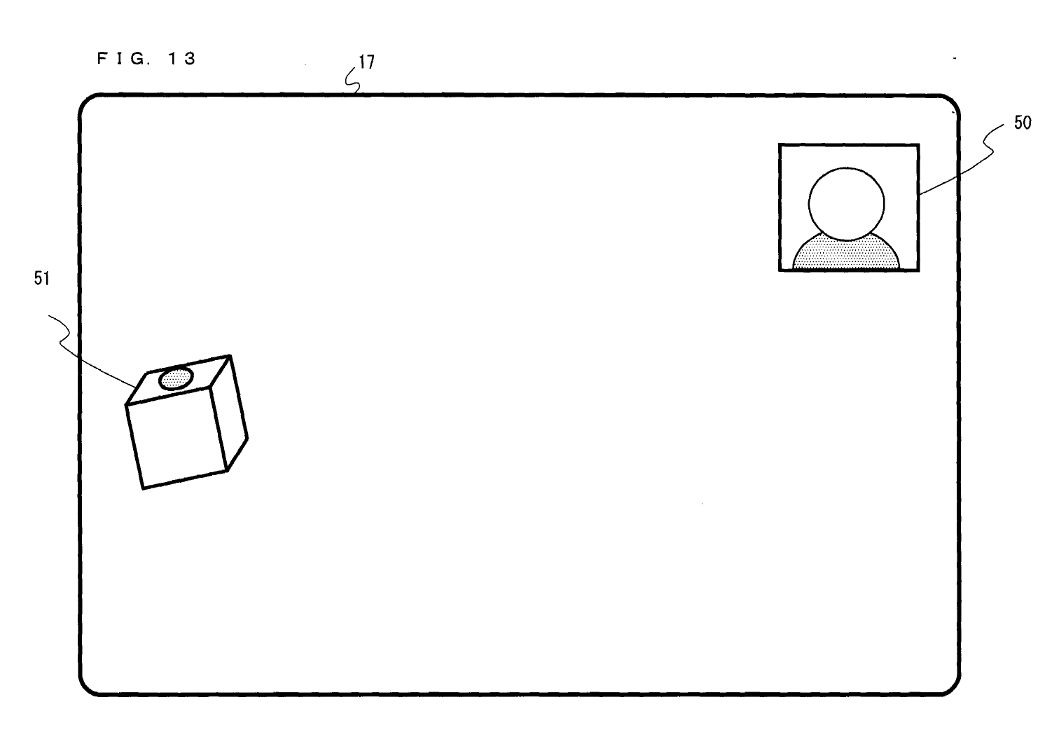

FIG. 12 is a flow chart showing the details of the die roll process shown in step S8. Referring to FIG. 12, the die 51 is first rolled, and the die 51 rolling to the left is shown in animation (step S31). Then, the value of the die 51 is randomly determined, and the value is displayed along with the character image 50 as shown in FIG. 13 (step S32). Then, the die roll process ends.

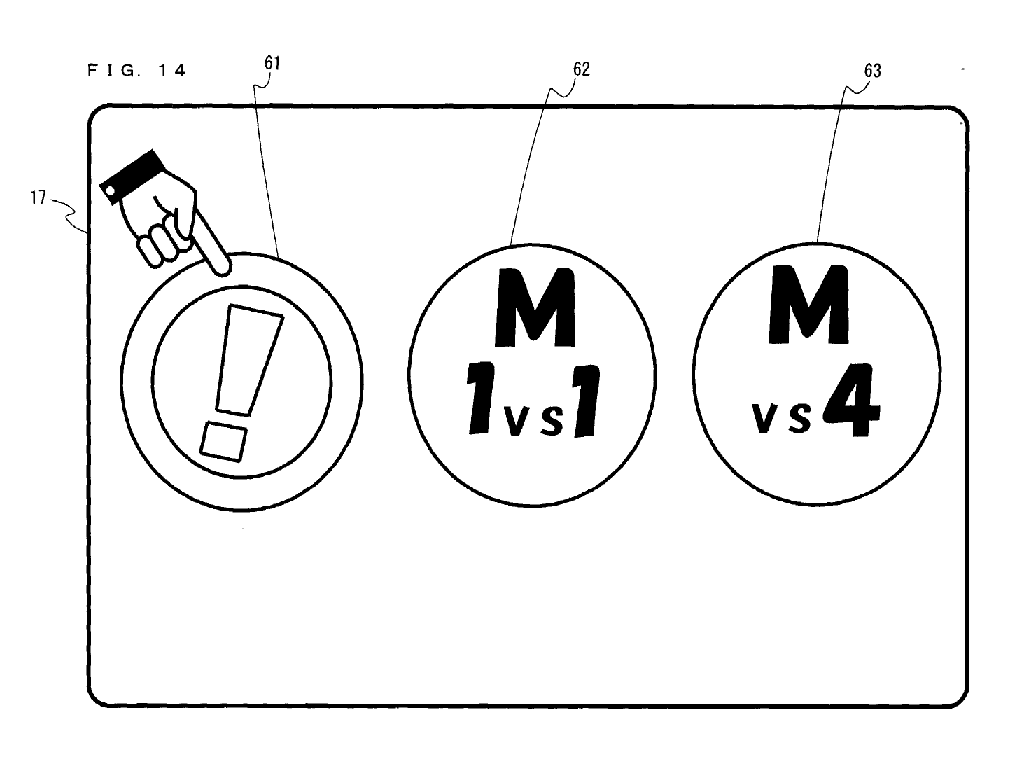

Referring back to FIG. 7, after the value is displayed in the die roll process, the process waits for a player input (step S9). Thus, after the value is displayed, the game device 10 waits until the player finishes moving the gamepiece according to the value. An input operation that the player should perform after moving the gamepiece will be described. If the gamepiece lands on a board event space 7 or a battle space 5 or 6, the player presses the L or R button 15d or 15e. Then, a space event menu as shown in FIG. 14 is displayed. If the gamepiece lands on a normal space 4, the player presses the A or B button to pass the turn to the next player.

In response to the input operation after the player moves the gamepiece, the CPU core 31 detects the key that has been pressed (step S9). If it is detected that the L button 15d or the R button 15e has been pressed (YES in step S10), the process proceeds to the space event process (step S12). If a button other than the L button 15d or the R button 15e has been pressed (No in step S10), the process proceeds to step S20 to determine whether the A or B button has been pressed (step S20). If the A or B button has been pressed (YES in step S20), the process proceeds to step S14 to pass the turn to the next player. If the A or B button has not been pressed (No in step S20), the process returns to step S9 to wait for a player's input.

If it is determined in step S7 that the A button 15a has not been pressed, it is determined whether the L or R button 15d or 15e has been pressed (step S11). If the L or R button 15d or 15e has been pressed (YES in step S11), the process proceeds to space event process (step S12).

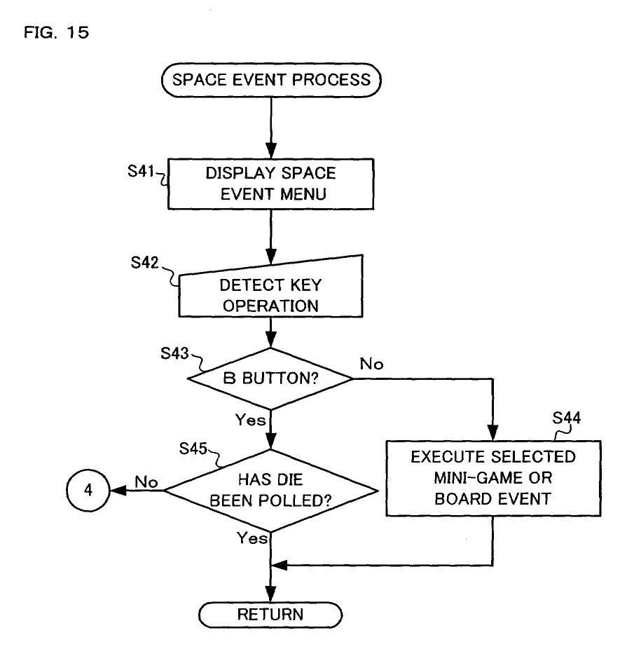

FIG. 15 is a flow chart showing the details of the space event process shown in step S12. In FIG. 15, the game device 10 displays, as a space event menu, a list of event space images that has been loaded in step S1 (step S41). With the board 1, the list looks as shown in FIG. 14. Referring to FIG. 14, there are displayed images 61, 62 and 63, corresponding to the board event space 7, the two-player battle space 5 and the four-player battle space 6, respectively (these images are drawn on the board with the same or similar design). The player uses the cross-shaped key to select the image corresponding to the space landed on. The player may press the B button 15b to cancel the menu screen. The CPU core 31 receives the player input and detects the key that has been pressed (step S42). If the B button 15b has been pressed (YES in step S43), it is determined whether the die has been rolled. In other words, it is determined whether the player has pressed the L or R button 15d or 15e, instead of pressing the A button 15a, on the die roll screen shown in FIG. 11 (step S45). If the die has been rolled (YES in step S45), the CPU core 31 directly exits the space event process. If the die has not been rolled (No in step S45), the process returns to step S5.

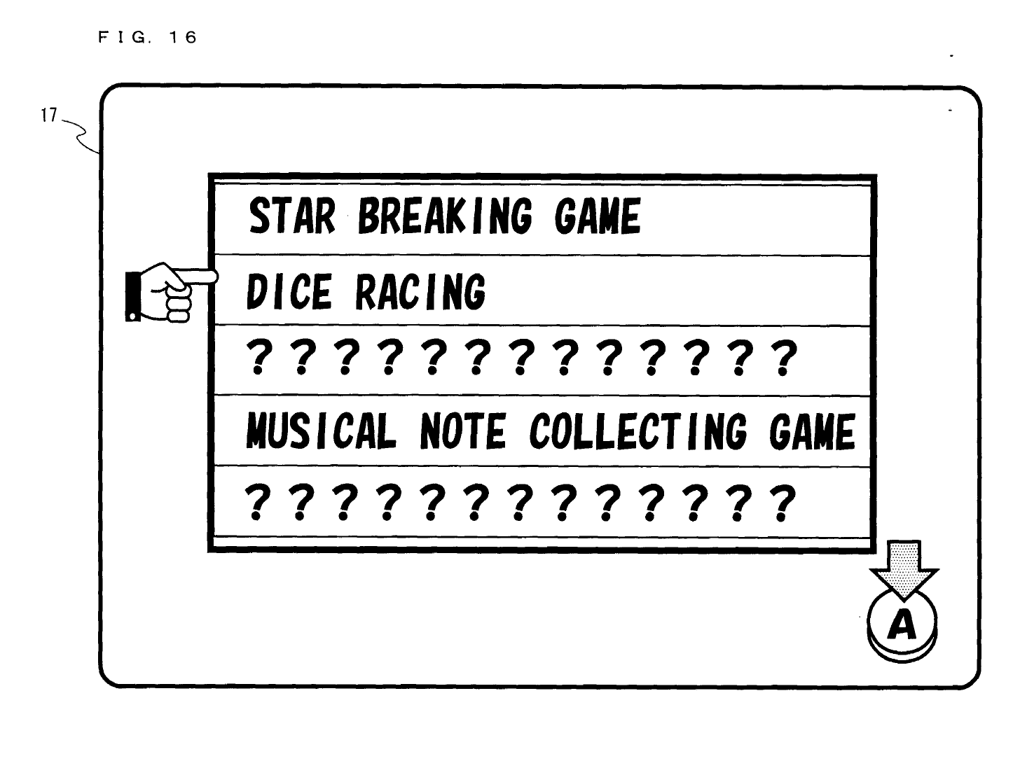

If a button other than the B button 15b has been pressed (No in step S43), a process corresponding to the selected event space image is executed (step S44). If the image 62 of a two-player battle space is selected in FIG. 14, one of a list of two-player battle mini-game programs is selected. A mini-game roulette is displayed as shown in FIG. 16, and one of the listed mini-games is randomly selected and executed. This applies similarly when the image 63 of a four-player battle space is selected. A mini-game is where the character selected by the player in step S2 is displayed on the screen, and the character is controlled according to the player input (the event character image data (for mini-games) in the WRAM 35 is used, and the character is controlled according to the player's operation on the control switches 15, etc.). For example, the player may control the character to race with other characters. If the player wins a mini-game, the game device 10 executes a process favorable to the player. For example, a screen as shown in FIG. 11 may be displayed with the character image 50 of the winner player (the event character image data (the image used for turn indication)), wherein the player is allowed to roll the die. In other words, an extra die roll process is executed according to the result of the mini-game (wherein the gamepiece is simply moved according to the value of the die without executing an event even if the gamepiece lands on an event space).

If the board event space image 61 is selected on the screen of FIG. 14, a board event program is executed. The direction in which an iron ball rolls down is determined randomly. Then, as shown in FIG. 4, the iron ball rolling down is shown in animation along with an arrow indicating the determined direction. With the board 1, there are four arrows for the upper right, lower right, upper left and lower left directions (each representing the direction in which the iron ball rolls down). In response to this, the player moves the game device 10 off the game device area 8 in one of the four (upper right, lower right, upper left and lower left) directions according to the arrow displayed (see FIG. 5). After moving the game device 10 to the end of the board, the player places the game device 10 back in the game device area 8. Then, the player presses the A button 15a to stop the iron ball animation. In other words, the iron ball animation continues until there is a player input. Thus, the space event process ends. Then, the process proceeds to step S14 to pass the turn to the next player. The board event program includes a display process for rolling the iron ball in the upper right direction, that for rolling the iron ball in the lower right direction, that for rolling the iron ball in the upper left direction, and that for rolling the iron ball in the lower left direction, one of which is selectively executed.

Referring back to FIG. 7, if it is determined in step S11 that the L or R button 15d or 15e has not been pressed (No in step S11), it is determined whether the start button 15f has been pressed (step S13 of FIG. 8). If the start button 15f has been pressed (YES in step S13), a process for passing the turn to the next player is executed (step S14). Then, the process returns to step S4. If the start button 15f has not been pressed either (No in step S13), it is determined whether the cross-shaped key 15c has been pressed (step S15). If the cross-shaped key 15c has been pressed (YES in step S15), the die is spun in place according to the input direction (step S16). If the cross-shaped key 15c has not been pressed either (No in step S15), it is determined whether the B button 15b has been pressed (step S17). If the B button 15b has been pressed (YES in step S17), an inquiry message is displayed asking the player whether or not to quit playing with the board and go back to the board selection screen (step S18). In response to the input from the player to the inquiry, it is determined whether the player has chosen to quit (step S19). If the player has chosen to quit (YES in step S19), the process returns to step S1. Otherwise (No in step S19), the process returns to step S4 to repeat the process. The process returns to step S4 to repeat the process also when it is determined in step S17 that the B button 15b has not been pressed (No in step S17). Thus, the game process of the first embodiment ends.

As described above, the first embodiment uses a board in combination with a game device, whereby players waiting for their turns can observe the entire board. Thus, it is easy to grasp the status of the game and to thereby devise strategies. Moreover, the game device itself is placed on the board and is moved across the board depending on the development of the game, whereby as compared with a case where everything is processed within the virtual game space, there can be introduced analog events, thus introducing more unpredictability to the gameplay. In other words, an analog element is added to the digital game process, thereby giving the players unpredictable enjoyment as compared with games that are all digital. Moreover, since it is not necessary to provide special mechanisms to the board itself, it is possible to inexpensively increase the variety of boards by creating a new board using spaces corresponding to event space images stored in the game device. Furthermore, the players can create boards of their own, thus giving a more flexible and varied gameplay. Since characters are displayed to indicate whose turn it is, each player can easily know when it is the player's turn.

While a space event menu is displayed in step S41 in present embodiment, the menu may not be displayed, in which case mini-games, etc., may be assigned different buttons in advance so that they can be executed by pressing the button assigned thereto. For example, the L button 15d may be assigned to the execution of the board event program 355, and the R button 15e to the execution of mini-games. Then, the process skips the menu display process of step S41, and proceeds directly to the detection of the input value in step S42. If the R button 15e is pressed, the mini-game program 354 maybe executed immediately. If the L button 15d is pressed, the board event program 355 may be executed.

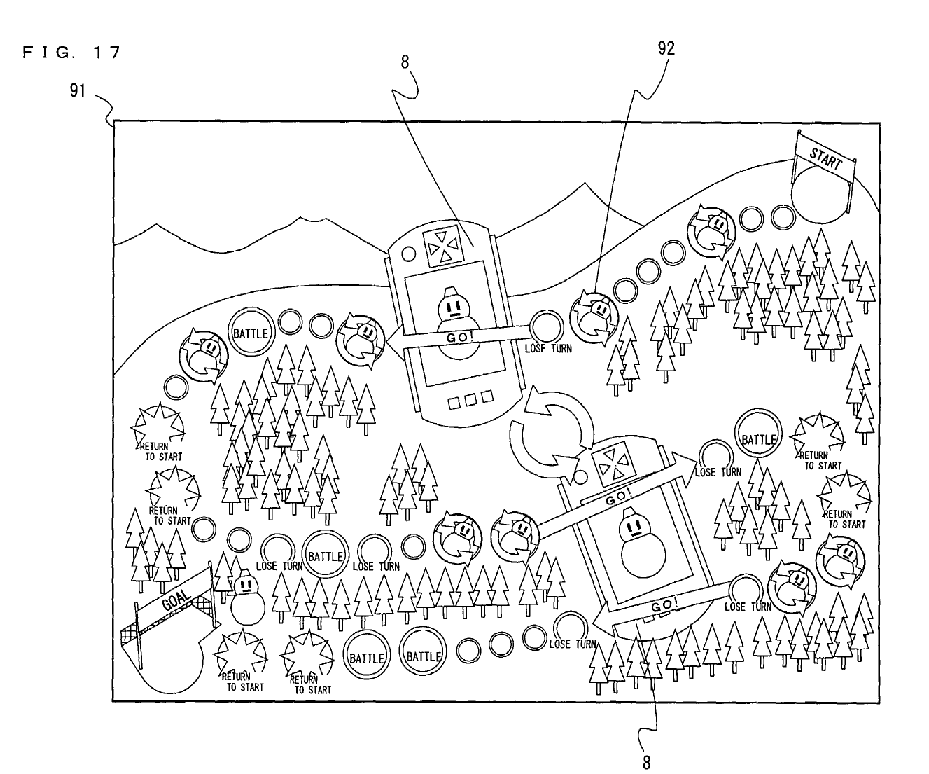

As to the placement of the game device 10, the game device 10 may be used as an obstacle for gamepieces moving along the track. FIG. 17 shows an exemplary board 91 where the game device 10 is used as an obstacle. The board 91 includes two game device areas 8. When a gamepiece lands on a space 92, the player moves the game device 10 from one game device area to the other. If the game device 10 is placed in the game device area 8 in front of a gamepiece, the gamepiece cannot move further from that position. The game device 10 displays an image of an obstacle character, indicating that gamepieces cannot pass through the position of the game device 10.

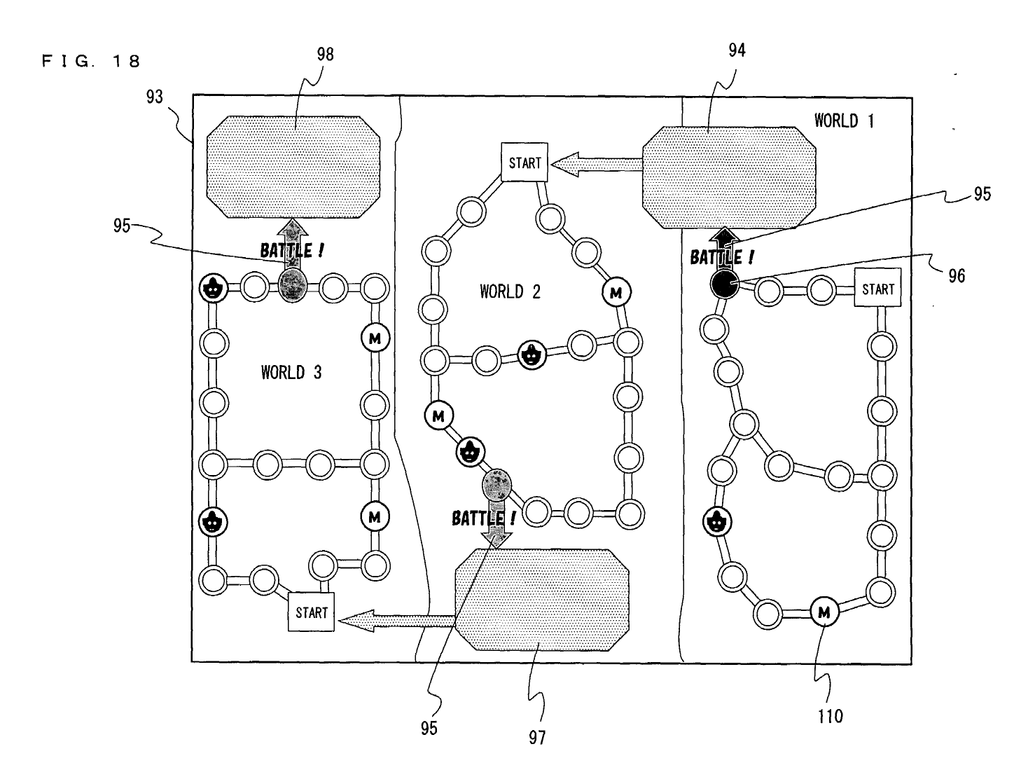

FIG. 18 shows another exemplary board 93 where the game device 10 is used as an obstacle. The board 93 of FIG. 18 includes three game device areas. At the start of the game, the game device 10 is placed in a game device area 94. At this point (e.g., in the beginning of the progress-related process after the preparatory process), the game device displays an image of a first boss character, indicating that gamepieces cannot move past this place. A connection 95 is drawn on the board 93, connecting a space 96 near the game device area to the game device area. If a gamepiece lands on the space 96 on the board 93, the player battles in a mini-game with the boss character being displayed on the game device 10. Specifically, after the gamepiece lands on the space 96, the player presses the L or R button 15d or 15e to start the mini-game. If the player wins, it means that the first boss character is defeated. Then, the game device 10 displays an indication that gamepieces are now allowed to move across the place, and also displays a message prompting the player to move the game device 10 to a game device area 97. After the player places the game device 10 in the game device area 97 according to the message, the player presses the A button to display the image of a second boss character. The connection 95 is drawn also near the game device area 97, where a player battles against a boss character in a mini-game. After winning the mini-game, the game device 10 displays a message prompting the player to move the game device 10 to a game device area 98. Then, the player presses the A button, and the game device 10 displays the image of a third boss character. In other words, with the board 93, the game device 10 is regarded as a boss character blocking the way of the players. In this example, when a screen as shown in FIG. 11 is displayed in step S5 of FIG. 7, the image of a boss character is displayed by being superimposed on the screen of FIG. 11. Thus, the boss character is displayed when the die is rolled, whereby the player is notified that the boss character is blocking the movement from World 1 into World 2 or the movement from World 2 into World 3.

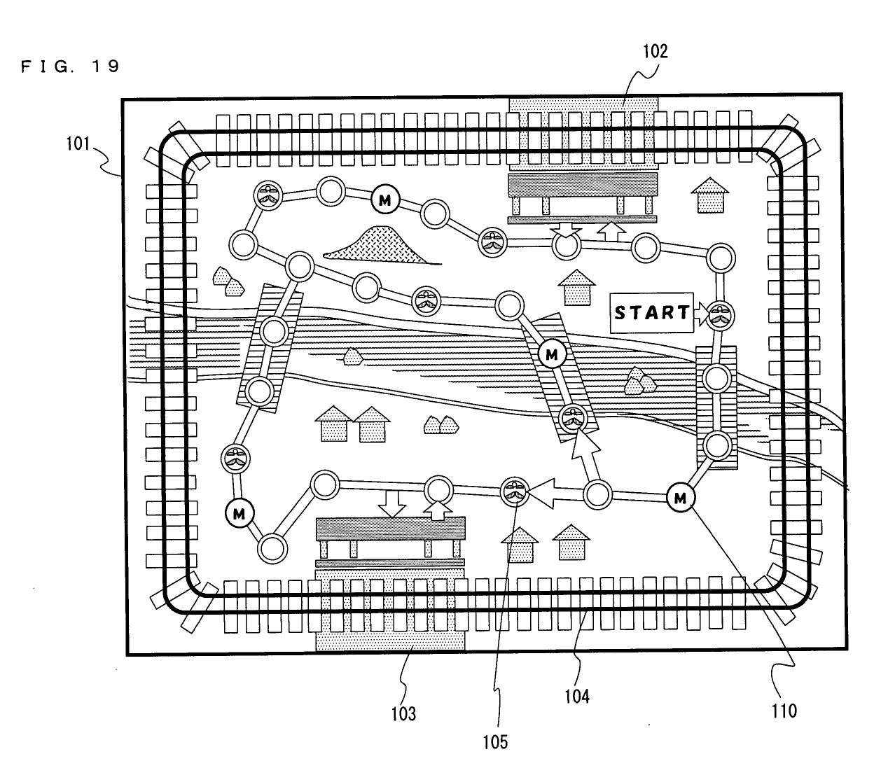

For the movement of the game device 10 off the game device area, the direction of movement may differ from one board to another. FIG. 19 shows a board 101 where the game device 10 is moved off the game device area according to the arrow displayed on the game device 10, as with the board 1 of FIG. 1. In FIG. 19, there are two game device areas 102 and 103. Also drawn on the board 101 is a railroad track 104. At the beginning of the game, the game device 10 is placed in the game device area 102. If the player performs an operation for executing a board event (S43) after landing on a board event space 105, the image of a train running to the right or the image of a train running to the left is randomly selected and displayed on the game device 10 (the game device 10 is then regarded as a train). With the board 101, the game device 10 itself is the goal position. With the board 101 (when the board 101 is selected in step S1), if the board event space image is selected on the screen as shown in FIG. 14, the board event program 355 corresponding to the board 101 is executed, wherein the direction of movement of the game device 10 is randomly determined to be either left or right. Then, the train running in the determined direction is shown in animation. The player moves the game device 10 along the railroad track 104 according to the direction shown on the screen. Any gamepiece hit by the game device 10 being moved across the board is returned to the start position. The player moves the game device 10 to the game device area 103 and places the game device 10 in the area 103. Thus, the game device 10 being the goal position is moved around.

There may be some event spaces that are common to different boards. For example, battle spaces 110 are drawn with the same design on the boards 93 and 101. With these boards, the space event menu displayed in step S41 includes the image of a board event space specific to each board and the image of a battle space as a common event space. If the common event space is selected, the mini-game process starts. Thus, by using common images and common processes for some events, it is possible to reduce the program size of the game program, thus efficiently using the capacity of the cartridge 11.

### Second Embodiment

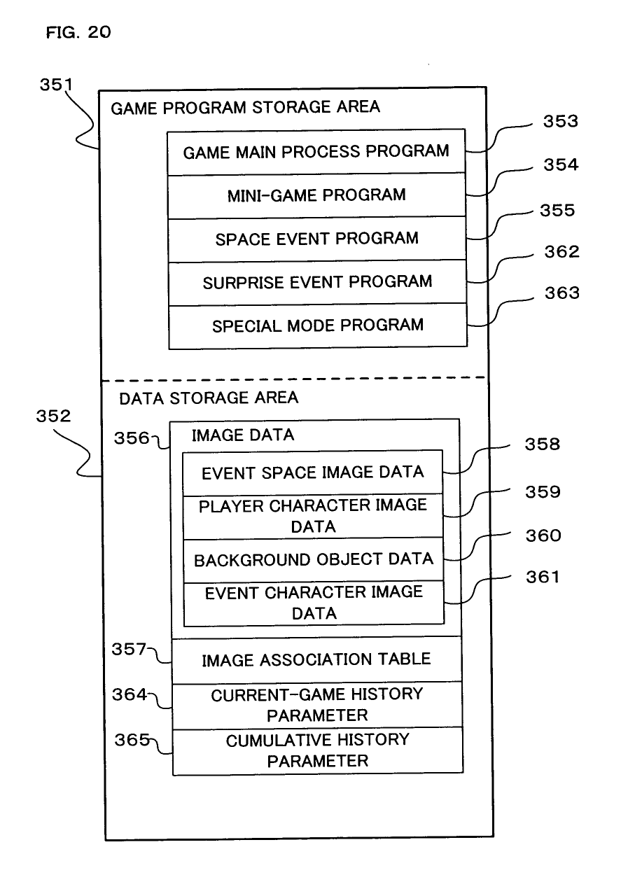

A second embodiment of the present invention will now be described with reference to FIGS. 20 to 24. In the second embodiment, the player's input operations and the results of mini-games executed are stored as history data. The history is used to execute a process, e.g., executing a predetermined event process at a predetermined point in time or adjusting the value of the die, irrespective of the player's intention. For example, one player may be so far ahead of the others in the middle to the end phase of a game that the other players might lose interest in the game, making it a dull game. In the present embodiment, the input operation of each player, e.g., the operation for rolling a die (the number of times the A button is pressed on the die roll screen) or the number of times the event process has been executed (or the number of times the L or R button has been pressed for the event process), is stored as a history parameter. Then, it is possible to make a rough estimate of how far advanced the game has been (i.e., the progress of the game). For example, it may be estimated that the game is entering the end phase when the board event has been executed a predetermined number of times or more or when the die has been rolled a predetermined number of times or more. Then, when the number of times the board event has been executed becomes greater than or equal to a predetermined value and it is accordingly estimated that the game is entering the end phase, a surprise or special event process may be executed that makes the game exciting. Such history-based event processes may be executed in the early to the middle phase of the game, instead of in the end phase.

The board 1 and the game device 10 of the present embodiment, which are the same as those of the first embodiment, will be denoted by the same reference numerals and will not be further discussed below.

FIG. 20 shows a memory map according to the second embodiment of the present invention. The memory map includes a surprise event program 362 and a special mode program 363 added to the program storage area of the memory map of the first embodiment. Moreover, a current-game history parameter 364 and a cumulative history parameter 365 are added to the data storage area 352.

The surprise event program 362 is a program for an event to be executed when the current-game history parameter 364 to be described later satisfies a predetermined condition. The surprise event program 362 includes, for example, a program for increasing the number of dice on the die roll screen before the die roll operation, a program for re-rolling a die on the die roll screen after the die once stops rolling (thus canceling the value of the first roll), a program for prompting a player to forcibly change the position of the gamepiece, a program for playing a special mini-game, a program for playing a mini-game with a special rule, and a program for prompting a player to perform a predetermined operation or to take a predetermined action. The special mode program 363 is a program to be executed when the cumulative history parameter 365 to be described later satisfies a predetermined condition. The variation of the special mode program 363 is the same as that of the surprise event program 362.

The current-game history parameter 364 is a parameter used for estimating the progress of the game, based on which an event can be executed in the end phase of the game. The current-game history parameter 364 stores the number of times a player has performed a predetermined input (an input for rolling a die or an input for executing an event process), and the execution history of the event process (e.g., the number of times the process of rolling a die has been executed, the number of times each event process has been executed, and the results of the event processes) More specifically, the current-game history parameter 364 includes, for example, a counter for recording the number of times each input has been made, a counter for recording the number of times each board event mini-game has been executed, and a counter for recording the number of times each player has won or lost in mini-games, etc. The current-game history parameter 364 is initialized each time a board game is played. Specifically, the current-game history parameter 364 is initialized when starting a new board game, or when starting a new board game after playing a board game to the end. More specifically, the current-game history parameter 364 is initialized when it is determined that a new board game is started or when it is determined that a board game is ended.

Unlike the current-game history parameter 364, the cumulative history parameter 365 is not used for the purpose of estimating the progress of the game, based on which an event can be executed in the end phase of the game. The cumulative history parameter 365 is used for the purpose of estimating how accustomed to the board game, or how experienced in the board game, the player has become. Then, an event, or the like, can be executed when it is estimated that the player has highly experienced so as to provide a new excitement to the player and thereby to keep the player interested in the game. The cumulative history parameter 365 stores the history over a number of games (or all games) played on the board game. For example, the cumulative history parameter 365 is initialized when the game device is started, and then accumulates history data until the game device is shut down. Thus, when a board game is played five times, the history of all the five games is cumulatively stored in the cumulative history parameter 365. The cumulative history parameter 365 may be initialized even before the game device is shut down if the user deliberately instructs to erase the data or the process means of the game device automatically erases the data after a special condition is satisfied. Where the cumulative history parameter 365 is stored in a non-volatile storage means, the cumulative history parameter 365 may cumulatively store the past history including, for example, the history from the previous time the game device was used, by not initializing the cumulative history parameter 365 each time the game device is started. The count of the current-game history parameter 364 and that of the cumulative history parameter 365 may be kept separately for each player character (i.e., when there is an input for rolling a die or an input for executing an event process, the game device 10 may update the current-game history parameter 364 and the cumulative history parameter 365 for the player character who has the turn), and they may be kept separately for each board.

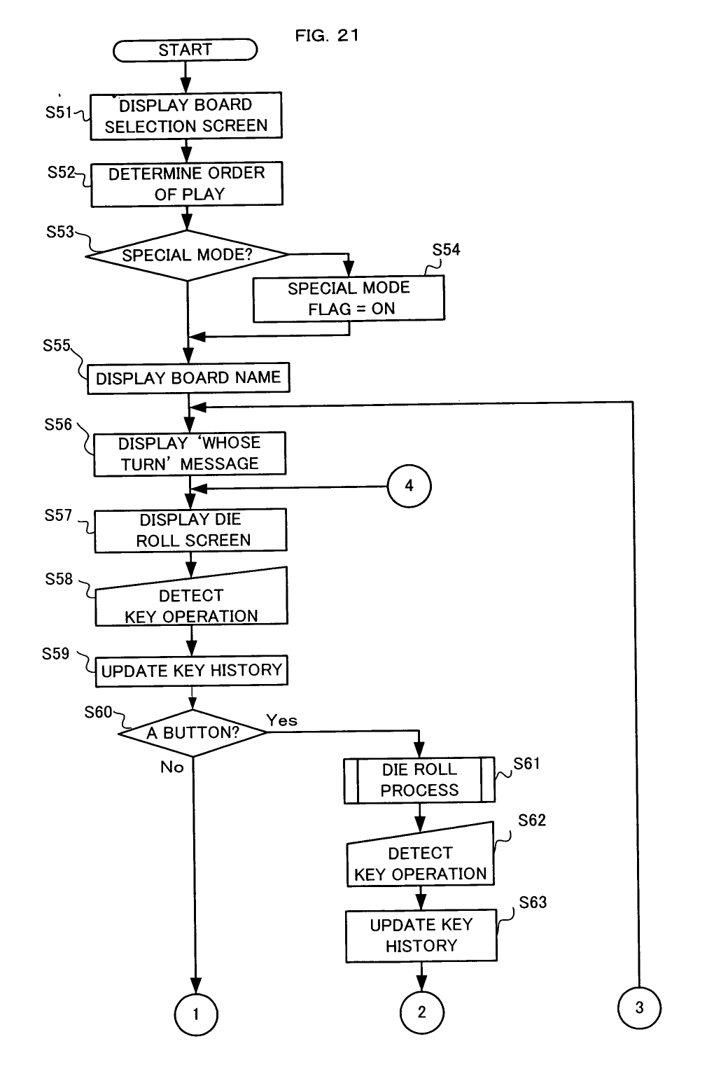

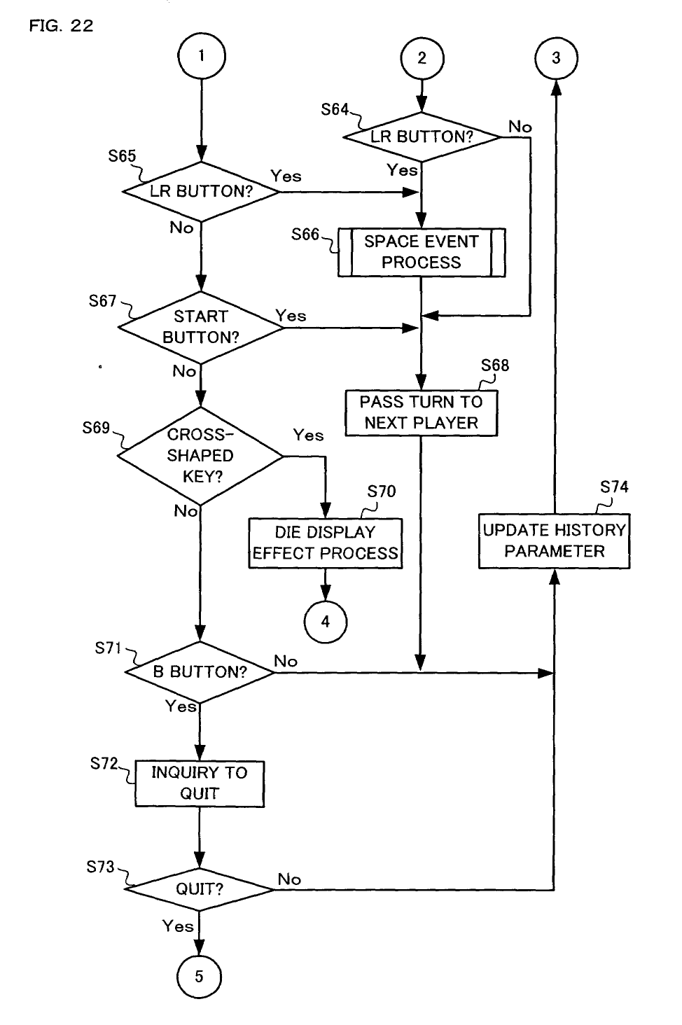

A game process according to the second embodiment of the present invention will now be described with reference to FIGS. 21 to 24. FIGS. 21 and 22 are flow charts showing the game process of the second embodiment. Steps S51 to S52 of FIG. 21 are the same as steps S1 to S2 described above in the first embodiment with reference to FIG. 7, and will not be further discussed below.

Referring to FIG. 21, after step S52, the CPU core 31 refers to the cumulative history parameter 365 to determine whether a condition for applying a special mode is satisfied (step S53). The condition is as follows. For example, assume that the cumulative history parameter 365 is stored separately for each board, and the cumulative history parameter 365 includes the number of times (Count 1) the board event space image shown in FIG. 14 has been selected and the event process has been executed, the number of times (Count 2) the two-player battle space image has been selected and the two-player battle mini-game has been executed, and the number of times (Count 3) the four-player battle space image has been selected and the four-player battle mini-game has been executed. Then, it may be determined that the condition is satisfied when, for example, Count 1, Count 2 and Count 3 are all 3 for the cumulative history parameter 365 for the board selected in step S51. If the condition is satisfied (YES in step S53), the CPU core 31 turns ON a special mode flag, which is a flag indicating whether the condition for applying a special mode is satisfied (step S54). Otherwise (No in step S53), the process proceeds to step S55.

Steps S55 to S57 are similar to steps S3 to S5 of the first embodiment, whereby a die roll screen as shown in FIG. 11 is displayed. After the die roll screen is displayed, the player's key operation is detected (step S58). Then, the current-game history parameter 364 and the cumulative history parameter 365 are updated by using the detected player's key operation as the key operation history (step S59).

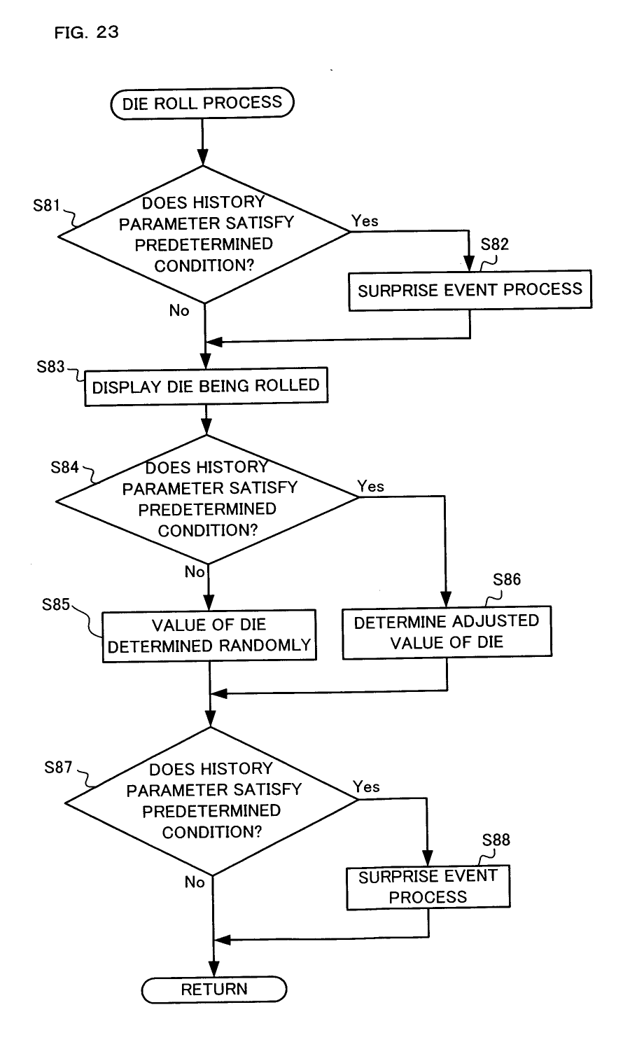

After step S59, it is determined based on the detected key operation whether the A button has been pressed (step S60). If the A button 15a has been pressed by the player (YES in step S60), the process proceeds to the die roll process (step S61). FIG. 23 is a flow chart showing the details of the die roll process shown in step S61. Referring to FIG. 23, first, the CPU core 31 refers to the current-game history parameter 364 to determine whether a predetermined condition is satisfied (step S81). The predetermined condition is, for example, the number of times the die has been rolled (the number of times an input for rolling a die has been made, i.e., the number of times the A button has been pressed as determined in S58 and the die roll process has been executed) being 15 or more. If the predetermined condition is satisfied, the surprise event program 362 is executed (step S82). The surprise event may be, for example, giving two dice instead of one, making the die bigger, suddenly starting a mini-game, etc. If the predetermined condition is not satisfied (No in step S81), the CPU core 31 displays the die being rolled (step S83).

Then, the CPU core 31 refers to the current-game history parameter 364 to determine whether a predetermined condition for adjusting the value of the die is satisfied (step S84). The predetermined condition is that, for example, the number of times the player character who has the turn has rolled the die is greater than or equal to a predetermined value and the number of times the board event has been selected is zero (the number of times an input for selecting the board event has been made is zero, i.e., the number of times a button other than the B button has been pressed in step S92 to be described later and the board event process has been executed in S98 is zero). If the condition is satisfied (YES in step S84), the CPU core 31 determines an adjusted value of the die (step S86). For example, the value of the die can be determined to be a six. If a player has not yet selected the board event even though the player has rolled the die many times, it is assumed that the player's gamepiece has not advanced so much. Such a slow player is given an advantage of a high value so that the player can catch up with the other players in order to keep the game exciting. Conversely, a player who has selected the board event the most times may be regarded as being too fast, and the value of the die for that player may be adjusted to a low value. If the predetermined condition is not satisfied in step S84 (No in step S84), the value is determined randomly as in the first embodiment (step S85).

Then, the CPU core 31 again refers to the current-game history parameter 364 to determine whether a predetermined condition is satisfied (step S87). If the predetermined condition is satisfied, the surprise event program 362 is executed (step S88). The surprise event program to be executed herein may be a program for prompting the player to roll the die again. Thus, the die roll process ends.

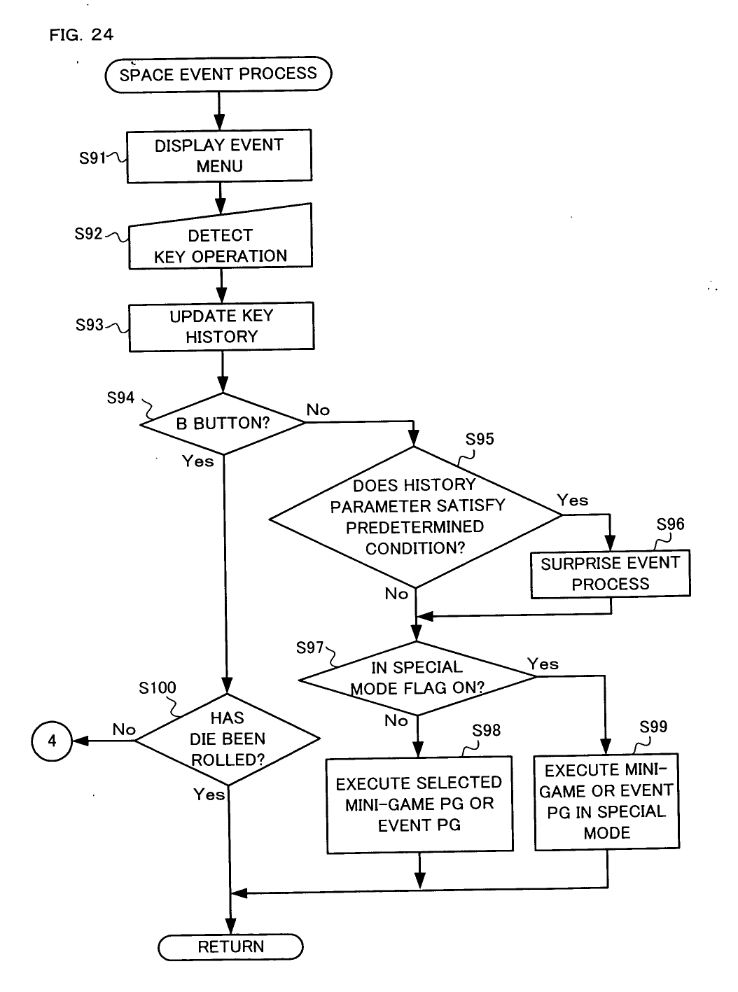

Referring back to FIG. 21, after the die roll process in step S61, the player's key operation is detected (step S62). Then, the current-game history parameter 364 and the cumulative history parameter 365 are updated by using the detected player's key operation as the key operation history (step S63). Then, it is determined based on the detected key operation whether the L or R button has been pressed (step S64 of FIG. 22). If the L or R button has been pressed (YES in step S64), the process proceeds to the space event process (step S66). Also if the A button 15a has not been pressed as determined in step S60 (No in step S60) and it is determined in step S65 that the L or R button 15d or 15e has been pressed (YES in step S65), the process proceeds to the space event process (step S66). FIG. 24 is a flow chart showing the details of the space event process shown in step S66. Referring to FIG. 24, first, the menu is displayed by a process similar to step S41 of the first embodiment (step S91), and the player's key operation is detected (step S92). Then, the CPU core 31 outputs the player's key operation (whether the A button or the L button has been pressed) to the current-game history parameter 364 as the key operation history (step S93). More specifically, the CPU core 31 increments the counter included in the history parameter 364 for recording the number of times each control button 15 has been pressed. If it is determined that the B button 15b has been pressed (YES in step S94), a process similar to step S45 in the first embodiment is executed (step S100).

If it is determined in step S94 that the B button 15b has not been pressed (No in step S94), the CPU core 31 refers to the current-game history parameter 364 to determine whether a predetermined condition is satisfied (step S95). If so (YES in step S95), the CPU core 31 executes the surprise event program 362 (step S96). The event program executed herein is, for example, a program for an event entitled “a great earthquake event”, wherein the game device 10 displays a message prompting a player to shake the board 1 itself. As the player shakes the board in response to the message, gamepieces on the board may jump around or move around across the board.

Then, it is determined whether the special mode flag is ON (step S97). If it is OFF, a board event or a mini-game as selected by the player is executed as in the first embodiment (step S98).

If it is determined in step S97 that the special mode flag is ON (YES in step S97), a selected event or mini-game is executed in a special mode (step S99). The special mode is, for example, a mode where a mini-game is played in such a manner that is favorable to a player, or a mini-game is started while a part of the screen is deliberately difficult to see. Once a mini-game, or the like, is executed in the special mode in step S99, the special mode flag is turned OFF. The present invention is not limited to executing a mini-game, or the like, under a special rule, but a special game, instead of a mini-game, may be executed as a special process. Thus, the space event process ends.

After the space event process, a process similar to steps S13 to S19 described above in the first embodiment with reference to FIG. 8 is executed (steps S67 to S73). In this series of steps, if a player does not choose to quit playing with the present board (No in steps S71 and S73), the current-game history parameter 364 and the cumulative history parameter 365 are updated (step S74). In this process, the results of the board events or mini-games executed (which player won, etc.) are outputted to the current-game history parameter 364 and the cumulative history parameter 365 as the execution history. The results of mini-games, etc., under the special rule are also outputted to the history parameter 364 and the cumulative history parameter 365 as the execution history.

Thus, the history of the results of mini-games executed and the player's operations is stored as history data. Based on the history data, a surprise event can be executed or an event or a mini-game can be executed in a special mode, whereby it is possible to give a change to the development of a game according to the progress of the game, thus providing more varied gameplay. Thus, it is possible to prevent the gameplay from becoming monotonous. Moreover, it is possible to prevent the game from being dull when, for example, one player is far ahead of the others. Moreover, as surprise events, there are introduced events with accidental effects, e.g., instructing the player to shake the board itself, thus realizing an even more varied gameplay and thus providing a game that players do not get bored with.

While the invention has been described in detail, the foregoing description is in all aspects illustrative and not restrictive. It is understood that numerous other modifications and variations can be devised without departing from the scope of the invention.

What is claimed is:

1. A board game system, comprising a board of a board game played by moving a gamepiece along a track formed by a plurality of spaces drawn on the board, and a game device for displaying a predetermined image on a screen, wherein:
the board includes at least one event space drawn thereon indicating that an event is to be executed by using the game device when a gamepiece lands on the space; and
the game device includes:
input accepting means for accepting an input from a player; and
event process executing means for executing an event process corresponding to the event space when there is a player input obtained by the input accepting means.

2. The board game system according to claim 1, wherein the game device includes:
event space image storage means for storing image data corresponding to the event space; and
event space display control means for displaying the event space image by using the image data,
wherein the event process executing means executes the event process when the event space image displayed by the event space display control means is selected by the player via the input accepting means.

3. The board game system according to claim 2, wherein:
a plurality of types of event spaces are drawn on the board;
the event space image storage means stores a plurality of image data corresponding to the plurality of types of event spaces;
the event space display control means includes menu display means for listing the plurality of types of event space images by using the plurality of image data;
the event process executing means executes the event process corresponding to the event space image selected by the player from among the listed event space images.

4. The board game system according to claim 1, wherein the game device further includes:
history parameter storing means for storing a history parameter indicating an execution history of the event process; and
history parameter updating means for updating the history parameter when the event process is executed in response to a player input obtained by the input accepting means,
wherein a predetermined process is executed at a predetermined point in time according to the history parameter.

5. The board game system according to claim 4, wherein the game device executes the predetermined process before or after executing the event process when the history parameter satisfies a predetermined condition.

6. The board game system according to claim 4, wherein:
the board game is played by advancing a gamepiece according to a value of a die;
the game device further includes die control means for repeating a process of determining a value of the die according to a player input and displaying the value on a screen; and
the game device executes the predetermined process before or after the process executed by the die control means when the history parameter satisfies a predetermined condition.

7. The board game system according to claim 1, wherein the game device further includes:
history parameter storing means for storing a history parameter indicating an execution history of the event process; and
history parameter updating means for updating the history parameter when the event process is executed in response to a player input obtained by the input accepting means; and
the event process executing means executes the event process in a special mode or executes a special process instead of executing the event process when the history parameter satisfies a predetermined condition.

8. The board game system according to claim 1, wherein
the board game is played by advancing a gamepiece according to a value of a die;
the game device further includes:
history parameter storing means for storing a history parameter indicating an execution history of the event process;
history parameter updating means for updating the history parameter when the event process is executed in response to a player input obtained by the input accepting means; and
die control means for determining a value of the die according to a player input and displaying the value on a screen; and
the die control means uses rules for determining the value that are varied between when the history parameter does not satisfy a predetermined condition and when the history parameter satisfies a predetermined condition.

9. The board game system according to claim 1, wherein
the history parameter storing means stores an execution count parameter indicating the number of times the event process has been executed;
the history parameter updating means updates the execution count parameter when the event process is executed in response to a player input obtained by the input accepting means; and
a predetermined process is executed at a predetermined point in time when the execution count parameter becomes equal to a predetermined count.

10. The board game system according to claim 1, wherein:
the game device is a portable-type game device;
a game device area is drawn on the board for placing the portable game device therein; and
the event process includes a moving instruction process for displaying an instruction to move a position of the portable game device placed in the game device area.

11. The board game system according to claim 10, wherein the moving instruction process selects one of a plurality of directions on a screen of the portable game device based on a random value and displaying the selected direction on the screen.

12. The board game system according to claim 11, wherein:
the board includes a plurality of types of boards;
the game device further includes board selection means for selecting a board to be used from among the plurality of boards based on a player input; and
the moving instruction process determines the plurality of directions and selects one of the plurality of directions according to the board selected by the board selection means.

13. The board game system according to claim 11, wherein the moving instruction process continuously displays the direction in which the portable game device is to be moved until the player makes a predetermined input.

14. The board game system according to claim 1, wherein:
the board includes a plurality of types of boards;
the game device further includes board selection means for selecting a board to be used from among the plurality of boards based on a player input;
the event process includes a board-specific event process specific to each board; and
the event process executing means executes the board-specific event process specific to the board selected by the board selection means.

15. The board game system according to claim 14, wherein:
a board-specific event space specific to each board is drawn on the board;
the game device further includes:
event space image storage means for storing image data corresponding to the board-specific event space; and
event space display control means for displaying, by using the image data, one of the board-specific event space images corresponding to the board selected by the board selection means;
the event process includes a board-specific event process for each board-specific event space; and
the event process executing means executes the board-specific event process corresponding to the board-specific event space when the board-specific event space image displayed by the event space display control means is selected by the player via the input accepting means.

16. The board game system according to claim 14, wherein:
a board-specific event space specific to each board and a common event space common to a plurality of boards are drawn on the board;
the game device further includes:
event space image storage means for storing image data corresponding to the board-specific event space and image data corresponding to the common event space; and
event space display control means for listing, by using the image data, the common event space image and one of the board-specific event space images corresponding to the board selected by the board selection means;
the event process includes a board-specific event process corresponding to the board-specific event space and a common event process corresponding to the common event space; and
the event process executing means executes the board-specific event process corresponding to the board-specific event space image when the board-specific event space image displayed by the event space display control means is selected by the player via the input accepting means, and executes the common event process when the common event space image displayed by the event space display control means is selected by player via the input accepting means.

17. The board game system according to claim 1, wherein:
the board game is played by advancing a gamepiece according to a value of a die;
the game device further includes die control means for displaying a prompt on the screen to make an input for determining a value of a die to accept a player input, and for determining the value of the die in response to the input to display the value on the screen; and
when a first input is made by the player after the value is displayed, the die control means executes again a process by the die control means, whereas when a second input is made by the player after the value is displayed, the die control means executes the event process and executes again a process by the die control means after the event process is executed.

18. The board game system according to claim 17, wherein:
the game device further includes:
character image storage means for storing a plurality of character images; and
display order determining means for determining a cyclic order in which the character images are displayed; and
the die control means displays a character image according to the determined display order together with, or prior to, the prompt, and displays the value, after which when the first input is made, the die control means displays the next character image according to the determined display order together with, or prior to, the prompt.

19. The board game system according to claim 18, wherein if a third input is made by the player after the die control means displays the prompt, the game device determines the value of the die based on the input, whereas if a fourth input is made by the player after the die control means displays the prompt, the game device displays the next character image according to the determined display order together with, or prior to, the prompt.

20. The board game system according to claim 1, wherein:
the board game is played by advancing a gamepiece according to a value of a die;
the game device further includes:
character image storage means for storing a plurality of character images;
display order determining means for determining a cyclic order in which the character images are displayed; and
die control means for displaying a prompt on the screen to make an input for determining a value of a die to accept a player input, and for determining the value of the die in response to the input to display the value on the screen;
the die control means displays a character image according to the determined display order together with, or prior to, the prompt; and
the event process is a mini-game process in which a character is controlled according to a player input using the character image.

21. The board game system according to claim 20, wherein the game device further includes post-mini-game die control means for selecting one character image based on the mini-game process, displaying a prompt to make an input for determining a value of the die along with a display of the character image or after a display of the character image to accept a player input, and for determining the value of the die in response to the input to display the value on the screen.

22. A board game system, comprising a board of a board game played by moving a gamepiece along a track formed by a plurality of spaces drawn on the board, and a portable game device for displaying a predetermined image on a screen, wherein:
the spaces, a game device area in which the portable game device is placed, and a connection between a space and the game device area are drawn on the board; and
the game device further includes display control means for displaying a predetermined game image on a screen of the portable game device and for changing how the game image is displayed according to an input from a player.

23. The board game system according to claim 22, wherein the display control means displays an indication on a screen of the portable game device indicating that a gamepiece cannot pass through a position of the portable game device, performs a predetermined process according to an input from the player, and displays an indication indicating that a gamepiece is now allowed to pass through the position of the portable game device if a result of the process satisfies a predetermined condition.

24. The board game system according to claim 22, wherein:
the board includes a plurality of game device areas drawn thereon; and
the display control means displays an indication on a screen of the portable game device indicating that a gamepiece cannot pass through a position of the portable game device, performs a predetermined process according to an input from the player, and displays an indication instructing the player to move the game device from the game device area to another game device area if a result of the process satisfies a predetermined condition.

25. The board game system according to claim 22, wherein:
the board game is played by advancing a gamepiece according to a value of a die;
the portable game device further includes die control means for displaying a prompt on the screen to make an input for determining a value of a die to accept a player input, and for determining the value of the die in response to the input to display the value on the screen; and
the portable game device displays the prompt or the value together with the predetermined game image at the same time on the screen.

26. A board game system, comprising a board of a board game played by moving a gamepiece along a track formed by a plurality of spaces drawn on the board, and a game device for displaying a predetermined image on a screen, wherein:
the board game is played by advancing a gamepiece according to a value of a die;
the game device includes:
character image storage means for storing a plurality of character images;
display order determining means for determining a cyclic order in which the character images are displayed; and
die control means for displaying a prompt on the screen to make an input for determining a value of a die to accept a player input, and for determining the value of the die in response to the input to display the value on the screen; and
the die control means displays a character image according to the determined display order together with, or prior to, the prompt, and displays the value, after which when the first input is made, the die control means displays the next character image according to the determined display order together with, or prior to, the prompt.

27. The board game system according to claim 26, wherein if a third input is made by the player after the die control means displays the prompt, the game device determines the value of the die based on the input, whereas if a fourth input is made by the player after the die control means displays the prompt, the game device displays the next character image according to the determined display order together with, or prior to, the prompt.

28. The board game system according to claim 26, wherein the game device further includes:
history parameter storing means for storing a history parameter indicating an input history of the player; and
history parameter updating means for updating the history parameter in response to a predetermined process being executed according to a player input obtained by the input accepting means,
wherein the die control means uses rules for determining the value that are varied according to the history parameter.

29. A board game system, comprising a board of a board game played by moving a gamepiece along a track formed by a plurality of spaces drawn on the board, and a game device for displaying a predetermined image on a screen, wherein:
the game device includes:
input accepting means for accepting an input from a player;
progress-related process means for executing a process relating to a progress of the board game when there is a player input obtained by the input accepting means;
history parameter storing means for storing a history parameter indicating an execution history of the progress-related process by the progress-related process means; and
history parameter updating means for updating the history parameter in response to execution of the progress-related process by the progress-related process means,
wherein a special process relating to the progress of the board gate is executed according to the history parameter.

30. A game device for displaying a predetermined image on a screen, the game device being used together with a board of a board game played by moving a gamepiece along a track formed by a plurality of spaces drawn on the board, wherein the board includes at least one event space drawn thereon indicating that an event is to be executed by using the game device when a gamepiece lands on the space, the game device comprising:
an input accepting section for accepting an input from a player; and
an event process executing section for executing an event process corresponding to the event space when there is a player input obtained by the input accepting means.

31. A game device for displaying a predetermined image on a screen, the game device being used together with a board of a board game played by moving a gamepiece along a track formed by a plurality of spaces drawn on the board, the game device comprising:
an input accepting section for accepting an input from a player;
a progress-related process section for executing a process relating to a progress of the board game when there is a player input obtained by the input accepting means;
a history parameter storing section for storing a history parameter indicating an execution history of the progress-related process by the progress-related process means; and
a history parameter updating section for updating the history parameter in response to execution of the progress-related process by the progress-related process means,
wherein a special process relating to the progress of the board game is executed according to the history parameter.

32. A storage medium storing a game program to be executed by a computer of a game device for displaying a predetermined image on a screen, the game device being used together with a board of a board game played by moving a gamepiece along a track formed by a plurality of spaces drawn on the board, wherein the board includes at least one event space drawn thereon indicating that an event is to be executed by using the game device when a gamepiece lands on the space, the computer being instructed to perform:
an input accepting step of detecting an input from a player; and
an event process executing step of executing an event process corresponding to the event space when a player input is detected in the input accepting step.

33. A storage medium storing a game program to be executed by a computer of a game device for displaying a predetermined image on a screen, the game device being used together with a board of a board game played by moving a gamepiece along a track formed by a plurality of spaces drawn on the board, the computer being instructed to perform:
an input accepting step of detecting an input from a player;
a progress-related process step of executing a process relating to the progress of the board game when a player input is detected in the input accepting step;
a history parameter storing step of storing a history parameter indicating an execution history of the progress-related process in the progress-related process step;
a history parameter updating step of updating the history parameter in response to the execution of the progress-related process in the progress-related process step; and
a special process step of executing a special process relating to a progress of the board game according to the history parameter.
